(19) United States
(12) Patent Application Publication
(10) Pub. No.: US 2023/0317997 A1
(43) Pub. Date: Oct. 5, 2023

(54) HIGH-PERFORMANCE HYDROXIDE EXCHANGE MEMBRANE

(71) Applicant: University of Maryland, College Park, College Park, MD (US)

(72) Inventors: Liangbing HU, Rockville, MD (US); Meiling WU, Berwyn Heights, MD (US); Xin ZHANG, Greenbelt, MD (US); Robert M. BRIBER, Bethesda, MD (US)

(21) Appl. No.: 18/194,121

(22) Filed: Mar. 31, 2023

Related U.S. Application Data
(60) Provisional application No. 63/362,358, filed on Apr. 1, 2022.

(51) Int. Cl. H01M 8/1025; H01M 8/1065; H01M 8/103

(52) U.S. Cl. CPC H01M 8/1025; H01M 8/1065; H01M 8/103; H01M 2008/1095

(57) ABSTRACT

The disclosure provides an ion exchange membrane with ion-conducting nanochannels formed by crosslinking chitosan molecular chains to form a unique threefold helical conformation and nanochannels that facilitate ion transport. The crosslinking promotes ion conductivity, suppresses swelling in water, inhibits fuel permeation, and enhances mechanical strength. The ion exchange membrane is stable in harsh alkaline environments. The ion exchange membrane can be used in a direct methanol fuel cell that displays an exceptional power density of 305 mW cm⁻².

### CROSS-REFERENCES TO RELATED APPLICATION(S)

This application claims priority to U.S. Patent Application No. 63/362,358 filed Apr. 1, 2022, which hereby is incorporated by reference in its entirety.

### STATEMENT REGARDING FEDERALLY SPONSORED RESEARCH

This invention was made with government support under 70NANB15H261 awarded by the National Institute of Standards and Technology (NIST). The government has certain rights in the invention.

### BACKGROUND

### 1. Field

This disclosure relates to ion exchange membranes that can facilitate transport of ions with wide applications in electrochemical devices, such as fuel cells, flow batteries, and electrolyzers.

### 2. Description of the Related Art

Ion exchange membranes feature positive or negative functional groups that can facilitate selective transport of counter ions, with wide applications in fuel cells, flow batteries, electrolyzers, and more [Ref. 1-4]. As the most widely used proton exchange membrane, Nafion™ features high proton conductivity, good stability, and excellent processability [Ref. 5]. However, its negatively charged sulfonic acid groups restrict its function to acidic environments [Ref. 3,6]. In contrast, anion exchange membranes, particularly hydroxide exchange membranes (HEMs), are operated under alkaline conditions, which enables the use of non-precious metal catalysts, bipolar plates and other stack components thus reducing costs substantially [Ref. 3,7]. For this reason, there has been increasing study of HEMs as an alternative to proton exchange membranes [Ref. 6,8,9], with several candidate materials developed based on polymers that feature cationic functional groups, such as ammonium, imidazolium, and pyridinium, for hydroxide conduction [Ref. 10-13]. However, under harsh basic operating conditions, these cationic groups are still prone to hydroxide attack, which results in the degradation and poor long-term chemical stability of HEM materials [Ref. 14-17]. As a result, it has remained an ongoing challenge to develop HEMs with high hydroxide conductivity and sufficient chemical stability in the harsh alkaline conditions needed for hydroxide exchange.

Researchers are increasingly turning to natural polymers for potential solutions to our energy needs due to their accessibility and enhanced sustainability compared to synthetic polymers. Converting the naturally abundant chitin (widely available in seafood biowaste [Ref. 18,19]) to chitosan produces the only polysaccharide that contains free amino groups, which in their cationic charged state can attract anions (e.g., OH—) for anion exchange applications (see FIG. 1A). However, chitosan displays an orthorhombic crystal structure made of linear and antiparallelly packed chains of the glucosamine units (GLUs) (FIG. 1A), which have strong hydrogen bonding [Ref. 20]. This crystal structure of chitosan limits ion transport, resulting in disappointingly low ionic conductivities [Ref. 8,21].

What is needed therefore are improved ion exchange membranes derived from natural sources that can facilitate transport of anions with wide applications in electrochemical devices, such as fuel cells, flow batteries, and electrolyzers.

### SUMMARY

The present disclosure addresses the foregoing needs by providing a chitosan material that can act as a hydroxide exchange membrane.

In one aspect, the disclosure provides an ion exchange membrane comprising a plurality of chitosan molecular chains crosslinked with a crosslinking agent selected from the group consisting of multivalent cations and mixtures thereof, wherein the ion exchange membrane has a structure including a crystalline crosslinking zone.

In another aspect, the disclosure provides an electrochemical device comprising: an anode; a cathode; and an ion exchange membrane positioned between the anode and the cathode, wherein the ion exchange membrane comprises a plurality of chitosan molecular chains crosslinked with a crosslinking agent selected from the group consisting of multivalent cations and mixtures thereof.

In yet another aspect, the disclosure provides a method for forming an ion exchange membrane. The method can include the steps of: (a) casting a flowable composition including chitosan on a support to form a chitosan membrane on the support; (b) advancing the support into a region wherein the chitosan membrane is contacted with a crosslinking agent selected from the group consisting of multivalent cations and mixtures thereof to form on the support an ion exchange membrane comprising a plurality of chitosan molecular chains crosslinked with the crosslinking agent; and (c) separating the ion exchange membrane from the support.

These and other features, aspects, and advantages of examples provided in the present disclosure will become better understood upon consideration of the following detailed description, drawings, and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a non-limiting example fuel cell in which an ion exchange membrane of the present disclosure can be used.

FIG. 1A shows the conversion of chitin biowaste to a chitosan-Cu HEM. Panel a is a digital photo of crab and shrimp waste, which was used to produce chitin and then chitosan by a demineralization-deproteinization-deacetylation process [Ref. 19,22]. The chitosan features an orthorhombic crystal structure, in which the α-chitosan chains are twofold symmetric. Panel b is a digital photo of a roll of the chitosan-Cu membrane produced by crosslinking chitosan with Cu²⁺, and a schematic illustration of the Cu²⁺-crosslinked chitosan chains, which feature a threefold helical conformation that results in nanochannels of ˜1 nm in diameter, which serve as selective ion transport pathways.

FIG. 2 shows the fabrication and characterization of the chitosan-Cu membrane. Panel a is digital photos of (left) chitin flakes obtained from crab shell, (middle) the chitosan acetic acid solution (4 wt. %) for casting the chitosan membrane, and (right) the chitosan membrane immersed in the Na₂Cu(OH)₄ solution to achieve Cu²⁺-coordination. Panel b is the final chitosan-Cu membrane (35 cm×13 cm), which is sufficiently thin and transparent to clearly see underlying text (Chitosan-Cu). Panel c is a side-view SEM image of the chitosan-Cu membrane, which is ˜5 μm thick. Panel d is a XPS Cu 2p spectrum of the chitosan-Cu membrane fitted with Cu²⁺²p_{3/2} and 2p_{1/2} peaks at 931.6 eV and 951.7 eV and their satellite peaks (marked with *). Panel e is the Cu K-edge XANES of the chitosan-Cu membrane, using CuO as a reference. The dashed lines in panel e indicate the Cu²⁺ pre-edge absorption at 8978.1 eV, characteristic Cu²⁺ shoulder absorption at 8985.8 eV, and main adsorption at ˜8995 eV, which are very similar to the XANES of CuO. Panel f is a Fourier-transformed Cu K-edge EXAFS of the chitosan-Cu membrane.

FIG. 3 shows the crystalline structure of chitosan and chitosan-Cu. Panel a is the 2D XRD pattern of the hydrated aligned chitosan. The arrow indicates the aligned direction of the chitosan nanofibers. The diffraction patterns of (100) and (020) indicate the orthorhombic crystal structure of chitosan. Panel b shows the molecular chain arrangement of chitosan along the chain direction (i.e., the c direction, indicated by the arrow) according to the crystal structure derived from the 2D XRD patterns. Panel c is a schematic diagram of the chitosan crystal structure. The hexagons denote the GLU, and the yellow and green lines represent the —NH₂ and —OH groups, respectively. Panel d is the 2D XRD pattern of the hydrated aligned chitosan-Cu. The diffraction patterns are labeled and indicated by the dotted ellipses. Panel e is the molecular chain arrangement of chitosan-Cu (hydrated and aligned) showing the Cu²⁺ coordination with the hydroxyl and amine groups of two adjacent chitosan chains. Grey, red, cyan, and blue spheres in panel b and panel e denote carbon, oxygen, nitrogen, and Cu atoms, respectively. Hydrogen atoms and water in the material are not shown in panel b and panel e for clarity. Panel f is a schematic diagram of the trigonal crystal structure of the hydrated chitosan-Cu. The a and b arrows indicate the unit cell of the chitosan-Cu crystal. Panel g is the 2D XRD pattern of the hydrated chitosan-Cu membrane (non-aligned with a semicrystalline structure). Panel h is the XRD curves of the hydrated chitosan-Cu membrane and aligned chitosan-Cu integrated from their respective 2D XRD data (FIG. 3g and FIG. 14a). Panel I is a schematic diagram of the semicrystalline structure of the chitosan-Cu membrane.

FIG. 4 shows the OH⁻ conductivity and alkali-stability of chitosan-Cu. In panel a, EIS was used to determine the OH⁻ conductivity of the chitosan and chitosan-Cu membranes. The inset shows the magnified Nyquist plot of the chitosan-Cu membrane. Panel b is the OH⁻ conductivity of the chitosan-Cu membrane as a function of the relative humidity. Panel c is a schematic diagram of the OH⁻ transport pathways in a chitosan-Cu nanochannel. The red dashed arrow indicates OH⁻ migrate together with water molecule clusters and the yellow arrows indicates OH⁻ transport via polar group sites (especially Cu²⁺). Panel d is the stability of the OH⁻ conductivity of the chitosan-Cu membrane and commercial Fumasep FAB-PK-130. The conductivities of both membranes were measured at RT and 100% relative humidity after different treatment times in 3 M NaOH at 80° C. The error bars represent the standard error of conductivity. Panel e shows digital photos of the chitosan-Cu membrane before and after the 1000-h stability test in 3 M NaOH solution. Panel f is the AIMD-simulated evolution of the bond distances between Cu and two N atoms (N_{I} and N_{II}) from amino groups and two O atoms (O_{I} and O_{II}) from hydroxyl groups in the chitosan chains over time for the model system of Cu²⁺-coordinated with chitosan (see FIG. 23, panel a).

FIG. 5 shows the application of the chitosan-Cu membrane in a DMFC. Panel a is the methanol permeability of the chitosan-Cu membrane and Nafion™ 212 as a reference. The permeability is measured without additional pressure. The thickness of the hydrated chitosan-Cu and Nafion™ 212 membranes was 110 μm and 55 μm, respectively. The diffusion coefficient (P) of chitosan-Cu is half that of the benchmark Nafion™ 212, indicating the chitosan-Cu membrane can alleviate fuel (methanol) crossover. The error bars represent the standard deviation of methanol permeability. Panel b is the tensile stress-strain curve of chitosan and chitosan-Cu membranes soaked in water. Panel c is the OH⁻ conductivity versus the mechanical strength of the chitosan-Cu membrane and other typical HEMs, including metallo-polyelectrolytes (permethyl cobaltocenium-functionalized polysulfone (Cp*₂Co⁺-PSf) [Ref. 33], polybenzimidazole (Cp₂Co⁺-PBI) [Ref. 39], and Bis(terpyridine)-Ru [Ref. 32]), ammonium-cationic polymers (tetraalkylammonium-functionalized polyethylene (tmAm-PE) [Ref. 11] and phenyltrimethylammonium-functionalized polysulfone (ptmAm-PSf50) [Ref. 10]), poly(arylene-imidazolium) (HMT-PMPIm) [Ref. 40], and commercial Fumasep FAB-PK-130. Panel d is a schematic diagram of a typical DMFC. Panel e shows a digital photo of the chitosan-Cu membrane coated with the cathode catalyst layer (shown in black), in which the chitosan-Cu membrane closely contacted the cathode catalyst layer. Grid scale: 1 cm. Panel f shows single cell polarization and power density curves of a DMFC featuring the 40-μm-thick chitosan-Cu membrane. The cell was operated at 80° C. and using 3 M methanol in 6 M KOH as the fuel source. No backpressure was used in the cathode. Panel g is a comparison of the power densities of DMFCs using chitosan-Cu and other ion exchange membranes including proton exchange membranes and HEMs.

FIG. 6 shows fabrication of the chitosan-Cu membrane. Photos of panel (a) chitosan solution (4 wt. %) in acetic acid with high viscosity, which was used to cast the chitosan film on a PET substrate using a doctor blade. Panel (b) shows the dried chitosan film and panel (c) shows the chitosan film roll. Panel (d) shows the rolled chitosan membrane was soaked in saturated Na₂Cu(OH)₄ solution to achieve Cu²⁺-coordination with the chitosan molecular chains. Panel (e) shows a roll of the final chitosan-Cu film, which is facile and inexpensive to fabricate.

FIG. 7 shows a schematic of a continuous roll-to-roll fabrication protocol for the chitosan-Cu membrane. The process involves chitosan film printing and drying, soaking in Na₂Cu(OH)₄ solution, and collecting the resulting chitosan-Cu membrane from the PET film support. The compatibility of chitosan-Cu with roll-to-roll manufacturing suggests its potential for large-scale production.

FIG. 8 shows the morphology of the chitosan-Cu membrane. Panel (a) shows an SEM image of the chitosan-Cu membrane surface, and panel (b) its corresponding EDX mapping, which shows homogeneous distribution of the Cu element in the chitosan-Cu membrane.

FIG. 9 shows XPS and IR analysis of the chitosan and chitosan-Cu membranes. Panel (a) shows the N 1s XPS spectra of the chitosan and chitosan-Cu materials. We ascribe the new peak in the chitosan-Cu membrane at 402.3 eV to the formation of the Cu—N bond [Ref. 1]. Panel (b) shows FTIR measurements of the chitosan and chitosan-Cu membrane. The absence of the bending vibration of the —NH₂ group at ˜1550 cm⁻¹ in the chitosan-Cu membrane indicates the formation of the Cu—N bond.

FIG. 10 shows photographs and morphology characterization of the aligned chitin, chitosan, and chitosan-Cu materials. Panel (a) shows digital photos of aligned chitin, chitosan and chitosan-Cu samples derived from crab tendon, from left to right. SEM images of panels (b, c) aligned chitin, panels (d, e) aligned chitosan, and panels (f, g) aligned chitosan-Cu. The images of panels (c), (e), and (g) are magnified SEM images of the areas in the red rectangles of panels (b), (d), and (f), respectively, which reveal the aligned chitin, chitosan, and chitosan-Cu are made of nanofibers with diameter of <50 nm. The arrow on the right indicates the direction of the aligned nanofibers.

FIG. 11 shows SEM and EDX characterization of aligned chitosan-Cu. Panel (a) is the SEM image of the chitosan-Cu, and panel (b) the corresponding EDS mapping. The uniform elemental distribution within the fiber morphology demonstrates the successful synthesis of the chitosan-Cu, which is composed of numerous highly aligned nanofibers.

FIG. 12 shows the crystal structure of aligned chitin. Panel (a) is the XRD pattern of the aligned chitin derived from Chesapeake blue crab tendon, demonstrating the formation of the α-chitin structure [Ref. 2]. The arrow in panel (a) indicates the chitin chain direction of the aligned chitin. Panels (b) and (c) show the corresponding molecular packing arrangement of the hydrated aligned chitin projected panel (b) along the a-axis and panel (c) along the c-axis (c-axis is the chitin chain direction). Grey, red, and green spheres denote carbon, oxygen, and nitrogen atoms, respectively. Hydrogen atoms and water inside the membranes are not shown in panels (b) and (c) for clarity. The α-chitin is an orthorhombic crystal. The chitin molecules are twofold symmetric in the c direction (along the direction of the molecular chains) and antiparallel-packed along the b direction, forming a sheet structure parallel to the bc-plane. These sheets are further stacked along the a direction.

FIG. 13 shows another view of the crystal structure of aligned chitosan-Cu. Panel (a) shows a model of the crystalline structure of the chitosan-Cu, based on the crystalline and bonding configurations determined from XRD and XAS of chitosan-Cu; a and b indicate the unit cell of the trigonal chitosan-Cu and the angle between a and b is 120°. The distance between the (100) planes is 1.3 nm, based on which the unit cell parameters (a and b) are calculated to 1.5 nm. Panel (b) shows the inner pore structure of the aligned chitosan-Cu, which is ˜1 nm in diameter. The atoms are visualized in the space-fill style, in which grey, red, green, and blue spheres denote carbon, oxygen, nitrogen, and copper atoms, respectively. The trigonal crystalline chitosan-Cu forms hexagonal channels in the c direction, which is distinct from the orthorhombic chitin/chitosan crystal structures.

FIG. 14 shows 2D XRD analysis of panel (a) the dried and panel (b) rehydrated aligned chitosan-Cu. Panel (a) shows in comparison to the XRD of the wet aligned chitosan-Cu (FIG. 3, panel d), the dry aligned chitosan-Cu features diffraction peaks of (101), (102), (003) at the same location as the wet crystalline chitosan-Cu, while showing significantly broader peaks and the absence of the (100) peak. Therefore, the overall trigonal crystal structure of the chitosan-Cu was maintained after drying, though the material is less crystalline. Panel (b) shows after rehydrating the material by soaking in water, the 2D XRD patterns of the rehydrated chitosan-Cu is almost the same as that of the original wet form, indicating the chitosan-Cu crystal structure can be recovered from dry chitosan-Cu by rehydration.

FIG. 15 shows the Zeta potential of chitosan and chitosan-Cu suspensions at pH =7. The chitosan starting material is positively charged with a Zeta potential of 12 mV and can thus selectively attract OH⁻. This is a unique characteristic of chitosan compared to other polysaccharides, which do not have cationic groups and are negatively charged. The positive shift of the zeta potential of the chitosan-Cu indicates more positive charges in the chitosan-Cu membrane compared to the chitosan control due to the coordination of Cu²⁺.

FIG. 16 shows conductivity of chitosan-Cu and cellulose-Cu. The EIS spectra and calculated hydroxide conductivity of panel (a) the chitosan-Cu at 80° C. and panel (b) the chitosan-Cu and cellulose-Cu membranes at room temperature. All membranes are measured with 100% relative humidity.

FIG. 17 shows a comparison of the σ_{IEC} of the chitosan-Cu membrane and other typical HEMs reported in the literature. In this plot, we compare typical HEMs of most types of cationic polymers, with each type of cationic polymer indicated by the same colors (commercial Fumasep FAB-PK-130 in orange, sulfonium in brown [Ref. 3], phosphonium in green [Ref. 4], guanidinium in purple [Ref. 5,6], imidazolium in teal [Ref. 7,8], piperidinium in grey [Ref. 9,10], ammonium in pea green [Ref. 11-14], metallo-polymers in blue [Ref. 15-18], and chitosan-Cu in dark blue). Ion exchange capacity (IEC) describes the OH⁻ capacity that can transport through the membrane, which we measured to be 1.6 mmol g⁻¹ for the chitosan-Cu membrane (see Methods for details). σ_{IEC} is the OH⁻ conductivity normalized to the IEC, which decouples the conductivity from the contribution of the number of OH⁻ molecules and indicates the intrinsic mobility of OH⁻. The σ_{IEC} of the chitosan-Cu membrane is higher than that of most HEMs, indicating its fast OH⁻ transport ability, which is in addition to its advantage of stability under alkaline conditions.

FIG. 18 shows the water uptake versus relative humidity of the chitosan and chitosan-Cu membranes. The water uptake of the chitosan and chitosan-Cu membranes increases with the relative humidity, indicating the materials' ability to absorb water. At a relative humidity of 100%, the chitosan membrane adsorbs significantly more water than the chitosan-Cu sample.

FIG. 19 shows water uptake of the chitosan-Cu membrane and other typical HEMs reported in the literature. The chitosan-Cu membrane shows a moderate water uptake of 56% compared with other HEMs (˜12-155%) [Ref. 3-15,17-20].

FIG. 20 shows NMR analysis of the H₂O diffusion coefficient for the chitosan-Cu membrane at different water uptake. Panel (a) shows a 1D ¹H NMR spectra of the chitosan-Cu membrane with varied contents of injecting deionized water (e.g., 90% denotes the mass ratio between the water and the dry membrane). The sharp ¹H peak are assigned to the mobile water and the broad ¹H peak are assigned to the protons of Cu-chitosan. Panel (b) shows the H₂O diffusion coefficients of the chitosan-Cu membranes vs. water weight percentage as measured by ¹H PFG-NMR (see Methods of the Example). The H₂O diffusion coefficient of the chitosan-Cu membrane increases with the water uptake, indicating water aids in OW transport [Ref. 21] and contributes to the high OH⁻ conductivity of the chitosan-Cu membrane.

FIG. 21 shows stability of the chitosan-Cu membrane in 3 M NaOH at 80° C. for 1000 h. Panel (a) is a photo of (left) the pristine 3 M NaOH solution and (right) the NaOH solution after immersing the chitosan-Cu membrane for 1000 hours at 80° C. The NaOH solution showed a very light blue color after the stability test, suggesting that a minimal amount of Cu²⁺ ions dissolved into the solution. According to ICP-MS, relatively 4 wt. % of the Cu²⁺ that were originally coordinated in the chitosan-Cu dissolved into the solution after the 1000-h treatment at 80° C. Panels (b-c) show SEM images of the chitosan-Cu membrane panel (b) before and panel (c) after the stability test. The similar dense structure in panels b and c indicates there is no surface morphological change. Panels (d-f) show the 2D XRD patterns of panel (d) the pristine chitosan-Cu membrane and panel (e) the chitosan-Cu membrane after the stability test, and panel (f) their XRD profiles integrated from the 2D XRD data in panel (d) and panel (e). The XRD profile of the aligned chitosan-Cu is included for reference. After the stability test, the chitosan-Cu membrane displayed similar Bragg diffraction positions (compared with the aligned chitosan-Cu and pristine non-aligned chitosan-Cu), indicating the trigonal crystal structure was maintained. The sharper peaks of the chitosan-Cu membrane after the stability test (compared with the pristine membrane) suggest the crystallinity is enhanced (increased grain size), which we ascribe to a thermal annealing-induced ordering behavior (a common phenomenon of polymer assembly).

FIG. 22 shows a structural model of the chitosan-Cu system. Panel (a) shows a unit cell containing two chitosan chains connected by Cu²⁺ ions. There are 18 glucosamine units in the unit cell. Each unit cell contains three Cu²⁺ considering the threefold helical conformation. Each Cu²⁺ ion is paired with two OH⁻ to maintain neutrality. Panel (b) shows the chitosan-Cu system with 198 water molecules filled into the empty space of the structure. The ratio of Cu²⁺:GLU:H₂O (1:3:66) is directly taken from experimental measurements. The volume of the empty space for filling water molecules is 6261 Å³. Filling with 198 water molecules leads to a density of 0.95 g cm⁻³ for the water. This is close to the density of pure liquid water (1.0 g cm⁻³) at room temperature, indicating that we have liquid water surrounding the chitosan chains in the model. Panel (c) shows a model simplified to ⅓ of the chain length of that in panel b to make the system more compatible with AIMD simulations. The simplified model contains one Cu²⁺ ion, two OH⁻, six glucosamine units and 66 water molecules. In the figures, “view//chain” indicates perspective parallel to the chitosan chains, while “view⊥chain” refers to perspective perpendicular to the chitosan chains.

FIG. 23 shows the molecular structure of model systems of panel (a) Cu²⁺-coordinated with chitosan and panel (b) uncoordinated Cu²⁺ in a basic solution featuring chitosan, which are used for simulating and comparing their molecular stability. Top of panels (a) and (b): the molecular structures projected along the chitosan chain direction; bottom of panels (a) and (b): the molecular structures captured from the view facing the chitosan chain plane. The model system in panel (a) of Cu²⁺-coordinated with chitosan contains one Cu²⁺, six OH⁻, six GLUs and 62 H₂O. Two OH⁻ are bound with Cu²⁺ and the other four OH⁻ are from NaOH to simulate an environment of 3 M NaOH. In the model system of panel (b) uncoordinated Cu²⁺ in a basic solution, the material composition is the same as that of Cu²⁺-coordination system, but the Cu²⁺ in panel (b) is not bonded with GLU but in the environment of 3 M NaOH.

FIG. 24 shows the evolution of the time-averaged total energy of the model systems of Cu²⁺-coordinated with chitosan and uncoordinated Cu²⁺ in a basic solution featuring chitosan. The energy data for the first 10 ps for equilibration has been discarded. The total energy of the coordinated Cu²⁺ system is much lower than that of the uncoordinated Cu²⁺ system, which confirms that the coordinated Cu²⁺ is energetically favorable.

FIG. 25 shows the stability of the cellulose-Cu membranes in 3 M NaOH at 80° C. Digital photos of panel (a) the pristine cellulose-Cu membrane immersed in 3 M NaOH solution at room temperature, and panel (b) after immersing in 3 M NaOH solution at 80° C. for 3 days. The cellulose-Cu membrane broke down and dispersed in the alkaline solution after 3 days. In comparison, the chitosan-Cu membrane (FIG. 4, panel e) exhibits good structural stability in the 3 M NaOH solution at 80° C. for >1000 hours, indicating the strong Cu—N bond is important for the stability of the Cu complexation structure in the harsh alkaline solution.

FIG. 26 shows DFT simulation of the binding energy between Cu and the glucosamine/glucose units. Two glucosamine or glucose units and one Cu²⁺ were used to simulate the model system of chitosan-Cu and cellulose-Cu respectively. The formation schematic of the panel (a) 2Glucosamine-Cu²⁺ model system, panel (b) 2Glucose-Cu²⁺ model system, and panel (c) Cu(H₂O)4 model system. Panel (d) shows the simulated energy of every system and calculated binding energies of the chitosan-Cu and cellulose-Cu model systems. The binding energy of the Cu²⁺-glucosamine units (3.26 eV) is significantly larger than that of the Cu²⁺-glucose units (2.34 eV) and Cu²⁺-water (2.58 eV), suggesting the Cu—N bonds that only exist in chitosan-Cu are stronger than the Cu—O bonds in the cellulose-Cu system. This is consistent with the observed stability of the chitosan-Cu vs cellulose-Cu systems in FIG. 22. Thus, the chitosan-Cu is more stable than cellulose-Cu in alkaline solution, making it favorable for HEM applications.

FIG. 27 shows the methanol permeability of the cellulose-Cu membrane. The diffusion coefficient (P) of cellulose-Cu (1.58×10⁻⁶ cm² s⁻¹) is higher than the chitosan-Cu membrane (1.02×10⁻⁶ cm² s⁻¹), indicating the chitosan-Cu membrane has lower permeability. The error bars represent the standard deviation of methanol permeability.

FIG. 28 shows the mechanical properties of the chitosan and chitosan-Cu membranes. Panel (a) shows the tensile stress-strain curves of the dry chitosan and dry chitosan-Cu membranes. Panel (b) shows the tensile stress-strain curves of the dry cellulose-Cu membrane. Although dry chitosan-Cu has a similar tensile break strength (130 MPa) as chitosan, the chitosan-Cu membrane shows a much higher yield strength (66 MPa) than the chitosan (26 MPa,) and cellulose-Cu membranes (15 MPa). Panels (c, d) show digital photos of the panel (c) chitosan and panel (d) chitosan-Cu membranes soaked in water for 1 hour. While the chitosan chains are closely packed with small molecular spacings, chitosan is highly hydrophilic and thus prone to swelling in water or 100% humidity. Thus water-soaked chitosan has low mechanical strength. In contrast, the water-soaked chitosan-Cu membrane exhibits a much higher mechanical strength compared with chitosan soaked with water due to the strong coordination bond of Cu—N and Cu—O in chitosan-Cu. The water-soaked chitosan-Cu membrane remains flat and tough whereas the chitosan soaked with water swells and becomes too soft to serve as an ion exchange membrane.

FIG. 29 shows the swelling behavior of the chitosan-Cu and chitosan membranes. Digital photo of the panel (a) pristine chitosan-Cu and chitosan membrane, and panel (b) the membranes after immersing in water for 5 hours. The chitosan membrane swelled significantly after immersing in water, resulting in low mechanical strength, as shown in FIG. 5, panel b.

FIG. 30 shows a radar chart comparing the properties and performances of chitosan-Cu and several HEMs with typical cationic groups [Ref. 7,9,11,15]. The values were normalized by the maximum value of each characteristic. The stability time is quantified by the time that the HEM membranes can remain in alkaline solutions while retaining 90% of their initial OH⁻ conductivities. The cost was estimated based on the total price of the reagents used to synthesize the polymer HEMs (details in Tables 7-12).

### DETAILED DESCRIPTION

Before any embodiments of this disclosure are explained in detail, it is to be understood that the present disclosure is not limited in its application to the details of construction and the arrangement of components set forth in the following description or illustrated in the following drawings. The presented examples are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown and described, but are to be accorded the widest scope consistent with the principles and features disclosed herein. Skilled artisans will recognize the examples provided herein have many useful alternatives and fall within the scope of embodiments of the disclosure.

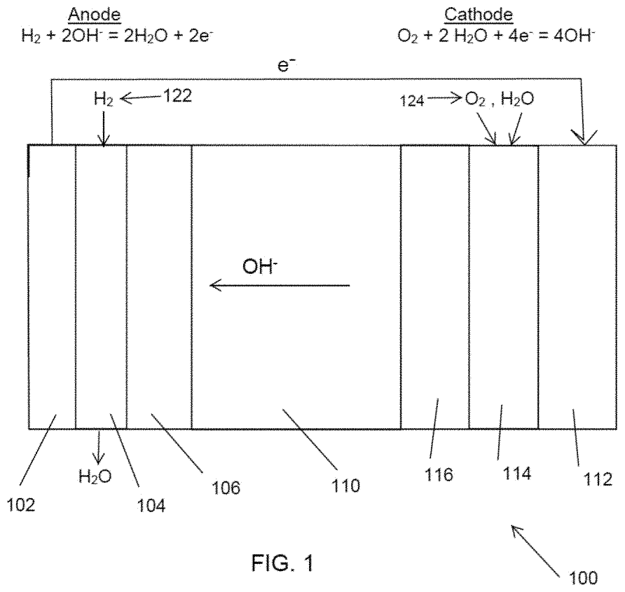

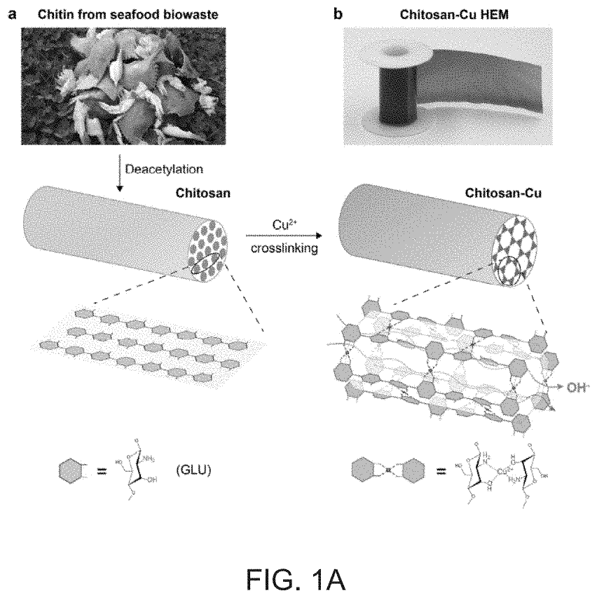

The ion exchange membranes of the present disclosure can be used in a hydroxide exchange membrane fuel cell (HEMFC) such as the non-limiting example HEMFC 100 as shown in FIG. 1, wherein the anode is depicted on the left and the cathode is depicted on the right. The anode includes an anode current collector 102, an anode gas diffusion layer 104, and an anode catalyst layer 106. The cathode includes a cathode current collector 112, a cathode gas diffusion layer 114, and a cathode catalyst layer 116. The anode catalyst layer 106 and the cathode catalyst layer 116 are separated by an electrolyte membrane 110. The electrolyte membrane 110 can be any of the anion exchange membranes of the present disclosure.

The anode carries out an anode half-reaction which oxidizes fuel releasing electrons to an external circuit and produces oxidized products. The cathode carries out a cathode half-reaction which reduces an oxidizer consuming electrons from the external circuit. The gas diffusion layers 104, 114 serve to deliver the fuel 122 (in this example, H₂) and oxidizer 124 (in this example, O₂) uniformly across the respective catalyst layers 106 and 116. In the case of the illustrated hydroxide exchange membrane fuel cell (HEMFC), the anode half-reaction consumes fuel and OH⁻ ions and produces waste water (as well as carbon dioxide in the case of carbon containing fuels). The cathode half reaction consumes oxygen and produces OH⁻ ions, which flow from the cathode to the anode through the electrolyte membrane 110. Fuels are limited only by the oxidizing ability of the anode catalyst and typically include hydrogen gas, methanol, ethanol, ethylene glycol, and glycerol. Preferably, the fuel is H₂ or methanol.

The anode catalyst layer 106 and the cathode catalyst layer include a catalyst. The term “catalyst” as used herein to refer to a material that increases the rate of a chemical reaction, e.g., by decreasing the activation energy required for reaction, and the term “electrocatalyst” as used herein refers to a material that increases the rate of an electrochemical reaction including one or more electron transfer steps. Further, with respect to an electrochemical reaction, the catalyst (or electrocatalyst) may decrease the potential required to initiate the reaction, or in other words, decrease the overpotential for the reaction. The type or kind of catalyst is not particularly limited as long as it is sufficiently active for the particular electrochemical application. In some embodiments, the catalyst may be a platinum group based catalyst material or a non-platinum group based catalyst material. Non-limiting examples of the catalyst may include platinum (Pt), rhodium (Rh), ruthenium (Ru), palladium (Pd), iridium (Ir), gold (Au), nickel (Ni), or mixtures thereof.

The use of an anion exchange membrane in the fuel cell 100 creates an alkaline environment inside the cell. The OH⁻ anion species crossing the membrane are generated according to an electrochemical oxygen reduction reaction at the cathode. The OH⁻ are transported to the anode where the fuel 122 (e.g., hydrogen, methanol) in contact with electrocatalysts undergoes an oxidation reaction to generate a molecule of water per single electron. In HEMFC 100, water is generated at the anode and, at the same time, water is a reactant at the cathode. The electrolyte membrane 110 should have the ability to allow the transport of OH⁻ ions while preventing fuel crossover and blocking the transport of electrons to prevent a short circuit. The HEMFC 100 may operate at a pH of 11 or greater, or at a pH of 12 or greater, or at a pH of 13 or greater.

The anode gas diffusion layer 104 and the cathode gas diffusion layer 114 provide support for the corresponding anode catalyst layer 106 and cathode catalyst layer 116. The anode gas diffusion layer 104 and the cathode gas diffusion layer 114 act as a transport channel for reactants and products which take part in the chemical reactions. The anode gas diffusion layer 104 and the cathode gas diffusion layer 114 may be a porous structure of carbon fibers, a non-woven carbon fiber material (i.e., carbon felt), or a woven carbon fiber material.

Chitosan is a natural material that includes a plurality of molecular chains of polysaccharides, more specifically, the molecular chains are a random distributed units of β-(1→4)-linked D-glucosamine (deacetylated unit) and units of N-acetyl-D-glucosamine. According to an aspect of the disclosure herein, the plurality of chitosan molecular chains can be crosslinked with a crosslinking agent to form an ion exchange membrane. The crosslinking agent can be selected from the group consisting of multivalent cations and mixtures thereof. The multivalent cations are selected from the group consisting of ions of copper, zinc, barium, calcium, magnesium, strontium, boron, beryllium, aluminum, iron, cobalt, lead, silver, and mixtures of any of these ions. In a particular embodiment, the multivalent cations are selected from the group consisting of ions of copper. The crosslinking agent coordinates between the chains along at least a portion of the chitosan molecular chains. The multivalent cations are coordinated with amino groups and hydroxyl groups of the chitosan molecular chains.

The plurality of chitosan molecular chains can be crosslinked by contacting the plurality of chitosan molecular chains with the crosslinking agent in an alkaline environment. The alkaline environment can include a solution of LiOH, NaOH, or KOH, for example. In one example, the plurality of chitosan molecular chains are crosslinked by contacting the plurality of chitosan molecular chains with the crosslinking agent as a metallic complex with hydroxyl. In an aspect, the membrane can include 1 wt. % to 10 wt. %, or 4 wt. % to 8 wt. %, of the crosslinking agent based on total weight percent of the membrane.

The long range order of the ion exchange membrane as disclosed herein is different from that of chitosan, as shown in FIG. 1A. According to an aspect of the disclosure, the ion exchange membrane can include a plurality of chitosan molecular chains. In an aspect, the chitosan molecular chains are substantially parallel. In one embodiment, the chitosan molecular chains have a threefold helical conformation.

Upon crosslinking, the chitosan chains twist along the chain axis to accommodate coordination by crosslinking agents such as ions between chains. In one embodiment, the ion exchange membrane can have a trigonal crystal structure. For example, the trigonal crystal structure can have a space group of P3₂21. In contrast, chitosan chains crystallize in an orthorhombic unit cell and a space group P2₁2₁2₁. In this way, the crosslinking provides the ion exchange membrane with a structure having a crystalline crosslinking zone.

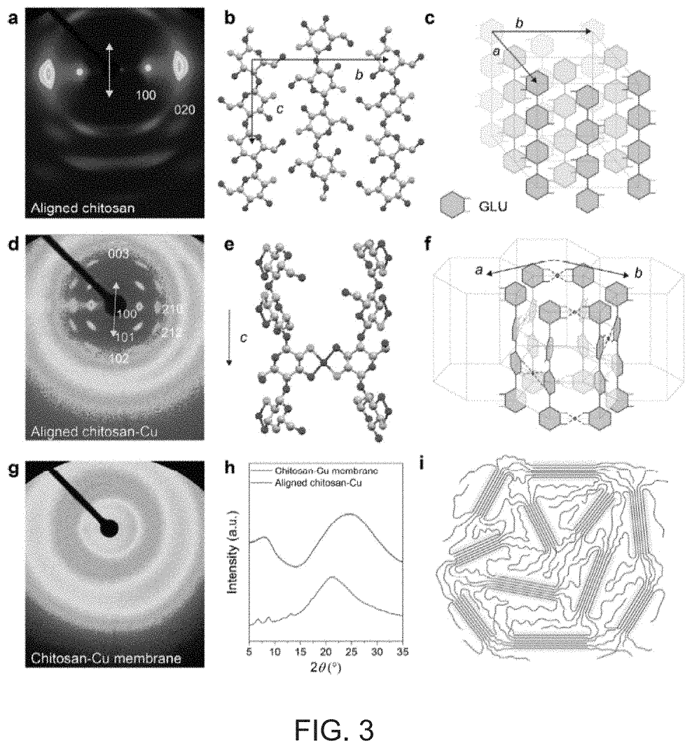

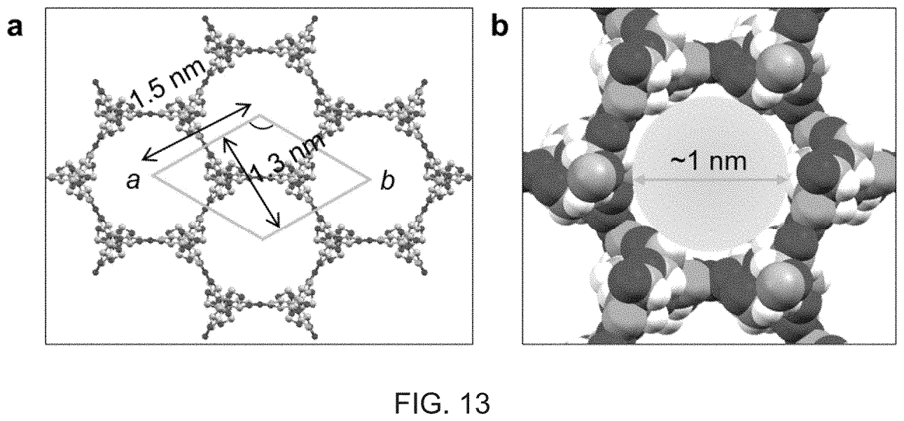

The organization of the chains in this way forms nanochannels. The nanochannels in the ion exchange membrane can be polygonal nanochannels as shown in FIG. 3, panel f, and FIG. 13. In other words, a cross section of the nanochannel taken perpendicular to the chitosan molecular chain direction shows the bounds of the nanochannel have a polygonal shape.

In a particular embodiment, the ion exchange membrane includes hexagonal nanochannels. For example, the hexagonal nanochannels can have a width in a range of 0.1 to 5 nanometers (see FIGS. 1, 3, and 4). In a further embodiment, the membrane can have a trigonal crystal structure in which six chitosan chains are bridged by Cu²⁺ to form a nanochannel having a width in a range of 0.5 to 1.5 nanometers oriented along chain direction. The ion exchange membrane as disclosed herein can facilitate ion transport through the nanochannels. In an embodiment, the ion exchange membrane can be an anion exchange membrane.

The ion exchange membrane as disclosed herein can accommodate fast water diffusion, as shown in Table 4. For example, the membrane as disclosed herein can have a water self-diffusion coefficient (D_{water}) greater than 10×10⁻¹⁰ m² s⁻¹ at 90% relative humidity. In another example, the membrane as disclosed herein can have a D_{water} greater than 15×10⁻¹⁰ m² s⁻¹ at 90% relative humidity, or greater than 5×10−10 m² s⁻¹ .

The ion exchange membrane as disclosed herein has a high ion exchange capacity as compared to previously reported examples of membranes. Furthermore, the ion exchange membrane facilitates anion conductivity. More specifically, the bridging Cu²⁺ ions in the ion exchange membrane facilitate the transport of anions, for example, the hydroxide anion. In one example, the ion exchange membrane can have a hydroxide conductivity of greater than 10 mS cm⁻¹ at room temperature. Additionally, and alternatively, the ion exchange membrane can have a hydroxide conductivity of greater than 20 mS cm⁻¹ at room temperature, or the ion exchange membrane can have a hydroxide conductivity of greater than 30 mS cm⁻¹ at room temperature, or the ion exchange membrane can have a hydroxide conductivity of greater than 40 mS cm⁻¹ at room temperature, or the ion exchange membrane can have a hydroxide conductivity of greater than 50 mS cm⁻¹ at room temperature. In yet another embodiment, the membrane can have a σ_{IEC} of greater than 30 mS g cm⁻¹ mmol¹. σ_{IEC} is the OH⁻ conductivity normalized to the IEC, which decouples the conductivity from the contribution of the number of OH⁻ molecules and indicates the intrinsic mobility of OH⁻.

The ion exchange membrane is dense and can take up less water than chitosan. In one embodiment, the ion exchange membrane has a water uptake of less than about 55%, less than 60%, less than 65%, or less than 70%.

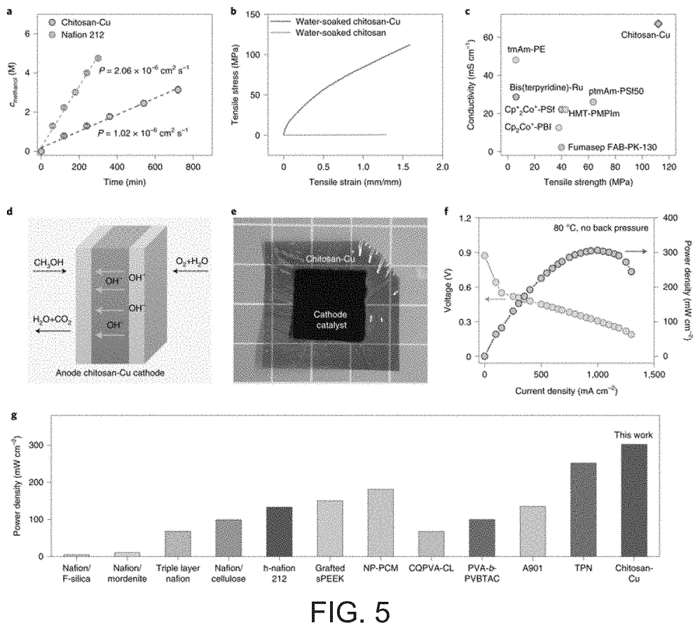

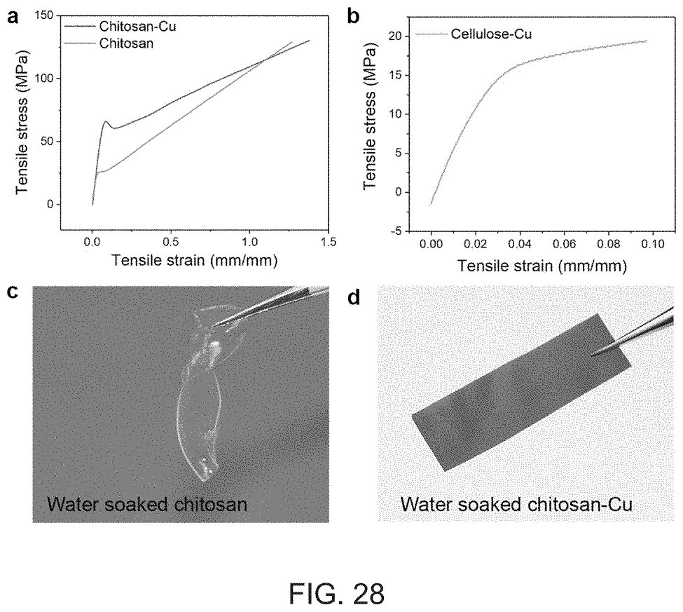

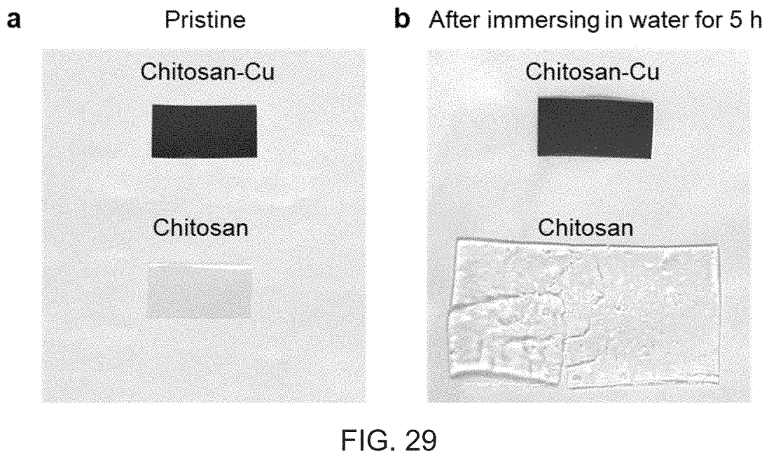

The mechanical strength of the ion exchange membrane can be increased by the crosslinking. For example, the crosslinking of the chitosan chains via coordination bonds increases the mechanical properties of the ion exchange membrane in a dry state (FIG. 28, panels a-b) and also in a hydrated state (FIG. 5, panel b, and FIG. 28, panels c-d, and FIG. 29). For example, the ion exchange membrane can maintain a tensile strength of at least 100 MPa when soaked with water. In another example, the ion exchange membrane can maintain a tensile strength of at least 80 MPa when soaked with water.

The ion exchange membrane can be used in a direct methanol fuel cell (DMFC) as it has low permeability to methanol. In one embodiment, the diffusion coefficient (P) of the ion exchange membrane is half that of the benchmark Nafion™ 212, indicating the ion exchange membrane can overcome the challenge of fuel (methanol) crossover. In another embodiment, the diffusion coefficient P of the ion exchange membrane is 1.02×10⁻⁶ cm² s⁻¹. In an embodiment, the membrane can have a methanol permeability of less than 1.5×10⁻⁶ cm² s⁻¹.

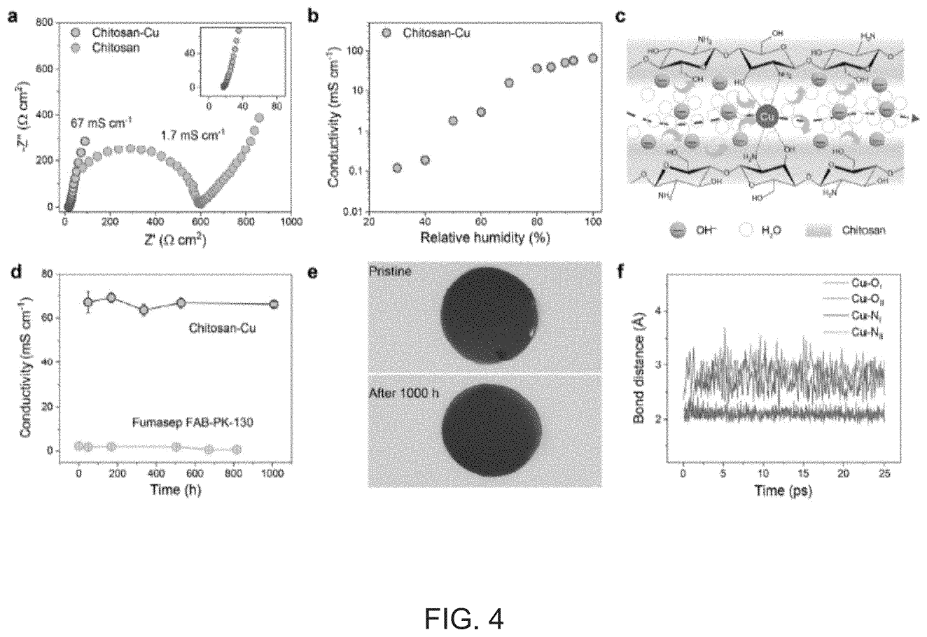

The ion exchange membrane exhibits stability towards alkaline conditions, as shown in FIGS. 4, 21, and 22. For example, the ion exchange membrane can be stable in 3 M NaOH at 80° C. for at least 1000 hours, where stability is determined by maintaining the original structure. The ion exchange membrane can maintain at least 96 wt. % of the originally coordinated Cu²⁺ in the ion exchange membrane after the 1000-hour treatment at 80° C. The ion exchange membrane can maintain a dense structure with no surface morphological change after the 1000-hour treatment at 80° C., as determined by SEM.

The XRD profile of the ion exchange membrane indicates the trigonal crystal structure can be maintained after the 1000-hour treatment at 80° C. In an embodiment, the ion exchange membrane is stable in a hydroxide solution exhibiting only 5% conductivity loss at 80° C. after 1000 hours.

According to an aspect as disclosed herein, the ion exchange membrane can be incorporated in an electrochemical device. In an embodiment, the electrochemical device can be an alkaline anion exchange membrane fuel cell.

The electrochemical device can include an anode. The anode can include a catalyst. The electrochemical device can include a cathode, where the cathode includes a catalyst material. The anode catalyst material and the cathode catalyst material can be a platinum group material or a non-platinum group material as described above.

The electrochemical device can include the ion exchange membrane positioned between the anode and the cathode. The ion exchange membrane can include a plurality of chitosan molecular chains crosslinked with a crosslinking agent and having nanochannels as described above. When incorporated in the electrochemical device, the ion exchange membrane has a water self-diffusion coefficient, ion transport properties, methanol permeability, and tensile strength as described above.

The electrochemical device can include a fuel flow path positioned to feed a fuel containing hydrogen and/or methanol into contact with the anode. The device can include an oxidant flow path positioned to feed an oxidant containing oxygen into contact with the cathode.

In an embodiment, the electrochemical device is a direct methanol fuel cell that exhibits a power density of greater than 300 mW cm⁻².

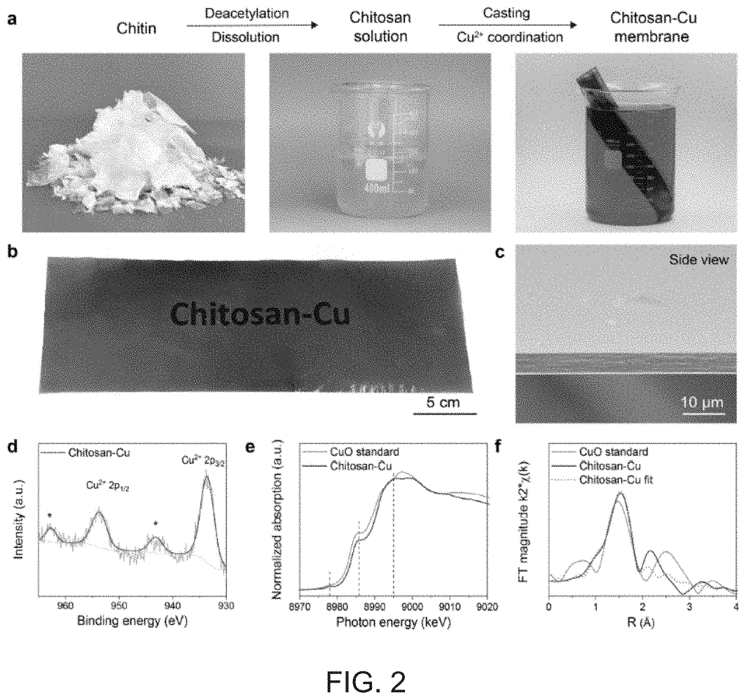

The ion exchange membrane can be formed according to the following method. A flowable composition including chitosan can be prepared from chitin, as described above and as shown in FIG. 2, panel a. The flowable composition can be cast on a support to form a chitosan membrane on the support. For example, the support can be a planar substrate, such as a PET film substrate. The support can be included as a roll that can be wound and unwound. The flowable composition can be made to form the chitosan membrane as a layer having a well-defined thickness on the support, such as by using a doctor blade. Additionally, and alternatively, the support can be a mold having a negative 3D shape corresponding to any desired form, such that the chitosan membrane is made in the desired form.

The support including the chitosan membrane can be advanced into a region wherein the chitosan membrane is contacted with a crosslinking agent. This step can include immersing the chitosan membrane on the support in a bath containing the crosslinking agent in an alkaline media. In an example, the chitosan membrane on the support can be immersed in a bath containing the crosslinking agent as a metallic complex with hydroxyl. Additionally, and alternatively, the region can be an open area where the crosslinking agent in an alkaline media can flow over and through the chitosan membrane on the support. The crosslinking agent can be selected from the group consisting of multivalent cations and mixtures thereof. For example, the multivalent cations can be ions of ions of copper, zinc, barium, calcium, magnesium, strontium, boron, beryllium, aluminum, iron, cobalt, lead, silver, and mixtures of any of these ions.

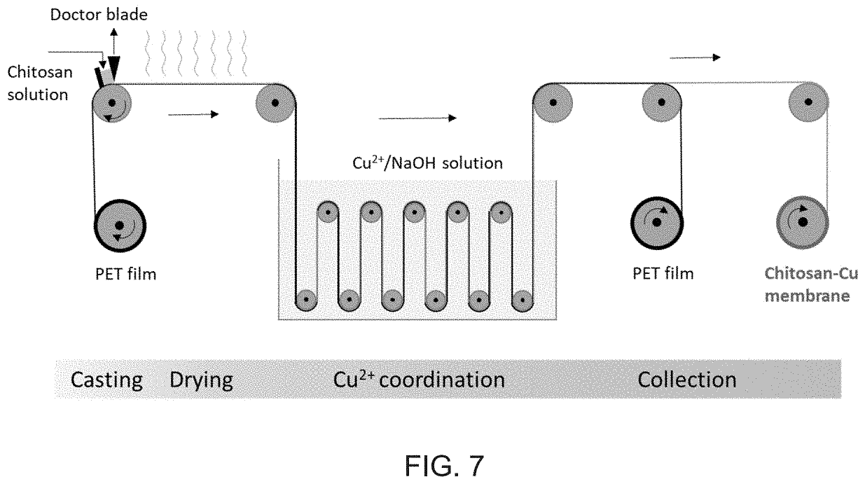

In an embodiment, the support can be transported on the roll to a zone where the flowable composition including chitosan is cast on the support as shown in FIG. 7. Contacting the chitosan membrane with the crosslinking agent while the chitosan membrane is on the support produces an ion exchange membrane comprising a plurality of chitosan molecular chains crosslinked with the crosslinking agent.

In a subsequent step, the ion exchange membrane is separated from the support. For example, the ion exchange membrane can be collected on a roll after separating the ion exchange membrane from the support. In another example, the ion exchange membrane can be removed from the mold.

### EXAMPLE

The following Example has been presented in order to further illustrate the aspects of the present disclosure and is not intended to limit the present disclosure in any way. The statements provided in the Example are presented without being bound by theory.

### 1. Overview of the Example

Ion exchange membranes are widely used to selectively transport ions in various electrochemical devices. Hydroxide exchange membranes (HEMs) are promising to couple with lower-cost platinum-free electrocatalysts used in alkaline conditions but are not stable enough in strong alkaline solutions. Herein, we present a Cu²⁺-crosslinked chitosan (chitosan-Cu) material as a stable and high-performance HEM. The Cu²⁺ ions are coordinated with the amino and hydroxyl groups of chitosan to crosslink the chitosan chains, forming hexagonal nanochannels (˜1 nm in diameter) that can accommodate water diffusion and facilitate fast ion transport, with a high hydroxide conductivity of 67 mS cm⁻¹ at room temperature. The Cu²⁺ coordination also enhances the mechanical strength of the membrane, reduces its permeability, and most importantly, improves its stability in alkaline solution (only 5% conductivity loss at 80° C. after 1000 hours). These advantages make chitosan-Cu an outstanding HEM, which we demonstrate in a direct methanol fuel cell (DMFC) that exhibits a high power density of 305 mW cm⁻². The design principle of the chitosan-Cu HEM, in which ion transport channels are generated in the polymer through metal-crosslinking of polar functional groups, could inspire the synthesis of many ion exchange membranes for ion transport, ion sieving, ion filtration, and more.

### 2. Introduction to the Example

Ion exchange membranes feature positive or negative functional groups that can facilitate selective transport of counter ions, with wide applications in fuel cells, flow batteries, electrolyzers, and more [Ref. 1-4]. As the most widely used proton exchange membrane, Nafion™ features high proton conductivity, good stability, and excellent processability [Ref. 5]. However, its negatively charged sulfonic acid groups restrict its function to acidic environments [Ref. 3,6]. In contrast, anion exchange membranes, particularly hydroxide exchange membranes (HEMs), are operated under alkaline conditions, which enables the use of non-precious metal catalysts, bipolar plates, and other stack components thus reducing costs substantially [Ref. 3,7]. For this reason, there has been increasing study of HEMs as an alternative to proton exchange membranes [Ref. 6,8,9], with several candidate materials developed based on polymers that feature cationic functional groups, such as ammonium, imidazolium, and pyridinium, for hydroxide conduction [Ref. 10-13]. However, under harsh basic operating conditions, these cationic groups are still prone to hydroxide attack, which results in the degradation and poor long-term chemical stability of HEM materials [Ref. 14-17]. As a result, it has remained an ongoing challenge to develop HEMs with high hydroxide conductivity and sufficient chemical stability in the harsh alkaline conditions needed for hydroxide exchange.

Researchers are increasingly turning to natural polymers for potential solutions to our energy needs due to their accessibility and enhanced sustainability compared to synthetic polymers. Converting the natural abundant chitin (wide availability in seafood biowaste [Ref. 18,19]) to chitosan produces the only polysaccharide that contains free amino groups, which in their cationic charged state can attract anions (e.g., OH⁻) for anion exchange applications (FIG. 1A). However, chitosan displays an orthorhombic crystal structure made of linear and antiparallelly packed chains of the glucosamine units (GLUs) (FIG. 1A), which have strong hydrogen bonding [Ref. 20]. This crystal structure of chitosan limits ion transport, resulting in disappointingly low ionic conductivities [Ref. 8,21]. In addition, the significant swelling and low mechanical strength of chitosan in aqueous solution, due to its high hydrophilicity, has further prevented its practical application as an ion exchange membrane.

In this Example, we report a chitosan-based anion conductor, in which ion-conducting nanochannels are formed by crosslinking the chitosan molecular chains with Cu²⁺ ions. In this chitosan-Cu material, Cu²⁺ ions coordinate with the amino and hydroxyl groups of chitosan to crosslink adjacent chains, which changes the twofold symmetric structure of the polymer chains to a unique threefold helical conformation. As a result, the orthorhombic crystal structure of chitosan converts to a trigonal crystal structure (FIG. 1A, panel b), in which six chitosan chains are bridged by Cu²⁺ to form a nanochannel with a diameter of ˜1 nm, oriented along the chain direction. The chelated Cu²⁺ ions in chitosan-Cu selectively promote the transport of anions (OH⁻ in this Example) within the nanochannels, with a high hydroxide conductivity of 67 mS cm⁻¹ at room temperature and 100% relative humidity. The Cu²⁺ crosslinking also suppresses the membrane from swelling in water, inhibits fuel permeation, and enhances the mechanical strength. Furthermore, the chitosan-Cu membrane demonstrates excellent chemical stability in harsh alkaline environments, enabling it to serve as a stable HEM. These features allow chitosan-Cu to serve as an effective HEM, which we demonstrate in a DMFC that displays an exceptional power density of 305 mW cm⁻²—a significant improvement compared to previously reported DMFCs. The chitosan-Cu material and its ion transport nanochannels generated through metal-crosslinking suggest a general approach to achieve high-performance ion exchange polymers.

### 3. Material Synthesis and Characterization

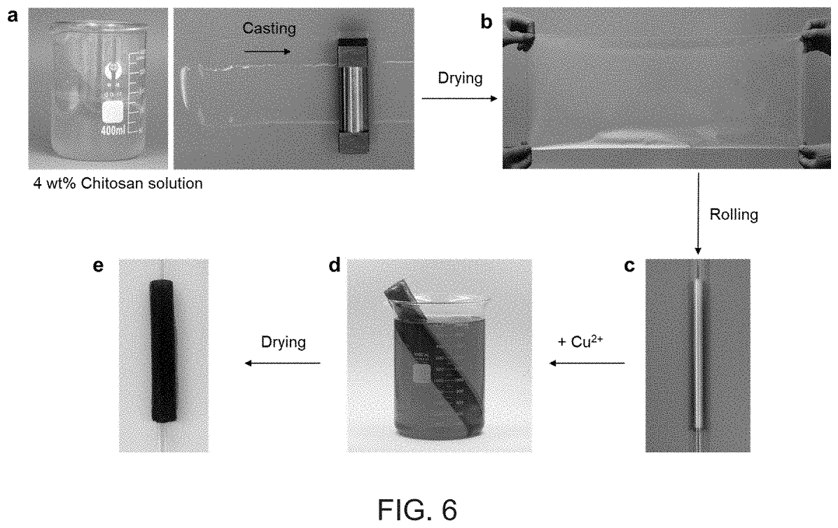

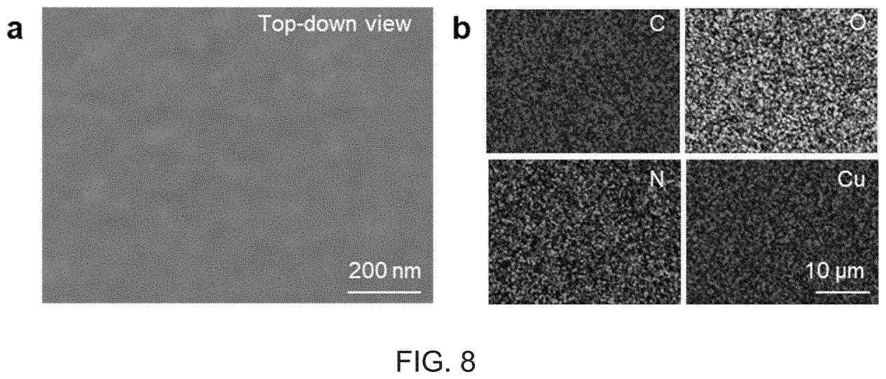

To synthesize the chitosan-Cu material, we first derived chitin from crab and shrimp shell waste using a demineralization and deproteinization treatment [Ref. 19]. We then heated the chitin in NaOH solution to conduct the deacetylation process [Ref. 22], during which the acetamide groups of the chitin chains transform to amino groups, producing chitosan. The chitosan was dissolved in acetic acid solution (4 wt. %, FIG. 2, panel a) and cast into a chitosan membrane (FIG. 6). The chitosan membrane was then immersed in a saturated Na₂Cu(OH)₄ solution until it turned completely blue and the color changed no further, forming the chitosan-Cu membrane (FIG. 2, panel b). This simple cast-dry-immersion process and the use of inexpensive reagents enable roll-to-roll production of the chitosan-Cu membranes at low cost (schematically illustrated in FIG. 7). The chitosan-Cu membrane is uniformly thin (5 μm), relatively dense, and has homogeneous Cu distribution as shown by scanning electron microscopy (SEM) and energy-dispersive X-ray spectroscopy (EDX) elemental mapping (FIG. 2, panel c, and FIG. 8). The Cu content in chitosan-Cu is 5.6 wt. % according to inductively coupled plasma mass spectrometry (ICP-MS, Table 1), corresponding to a Cu:GLU molar ratio of 1:6.

TABLE 1
The Cu concentration in the Na₂Cu(OH)₄ solution
and chitosan-Cu membrane, as measured by ICP-MS.

| | Na₂Cu(OH)₄ | Chitosan-Cu |
|---|---|---|
| Sample | solution | membrane |
| Cu concentration (wt. %) | 2.09 | 5.6 |

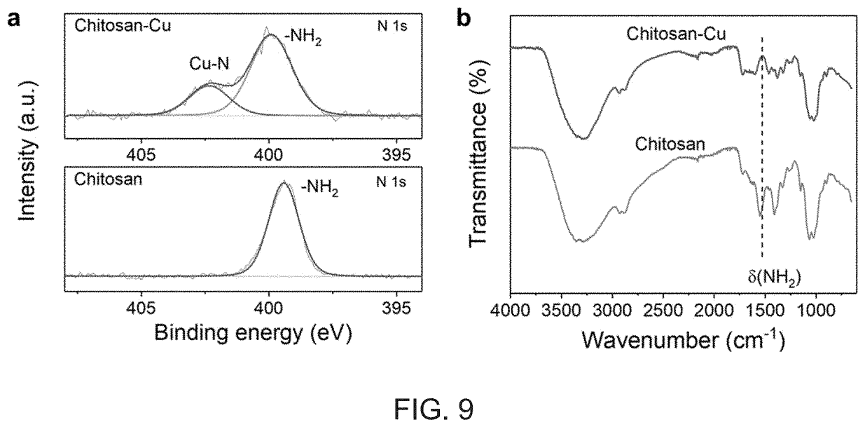

We analyzed the Cu valence and bonding in the chitosan-Cu membrane by X-ray photoelectron spectroscopy (XPS) and X-ray absorption spectroscopy (XAS). The Cu 2p XPS peaks at 931.6 eV and 951.7 eV and characteristic satellite peaks confirm the presence of Cu²⁺ in the chitosan-Cu membrane (FIG. 2, panel d). The Cu K-edge X-ray absorption near edge spectrum (XANES, FIG. 2, panel e) of chitosan-Cu shows characteristic absorption peaks of Cu²⁺, which also supports that the Cu in chitosan-Cu is in a +2 state. According to the Fourier-transformed extended X-ray absorption fine spectroscopy analysis (EXAFS, FIG. 2, panel f, and Table 2), the coordination number of Cu²⁺ is 4.2 and Cu²⁺ is coordinated with O and/or N atoms with a bond length of ˜1.96 Å (the Cu—N and Cu—O bonds cannot be distinguished since their bonding characteristics are similar). We verified the formation of Cu—N bonds by N 1s XPS and Fourier-transform infrared spectrum (FTIR) of chitosan-Cu (see detailed analysis in FIG. 9). Given the Cu²⁺ coordination number of 4.2 and the molecular structure of chitosan, we deduce that Cu²⁺ forms Cu—N and Cu—O coordination bonds in the chitosan-Cu membrane. Thus, the Cu²⁺ ions are coordinated with the amino and hydroxyl groups of the chitosan chains, which forms the chitosan-Cu complex.

TABLE 2
EXAFS coordination environment analysis of chitosan-Cu.

| Sample | Scattering Pair | CN | BD (Å) | σ² | ΔE₀ |
|---|---|---|---|---|---|
| Chitosan-Cu | Cu—N(O) | 4.2 | 1.98 | 0.005 | 4.6 |

CN: coordination number, BD: bond distance, σ²: mean-square disorder, and ΔE₀: energy shift.

### 4. Crystalline Structures of Chitin, Chitosan, and Chitosan-Cu

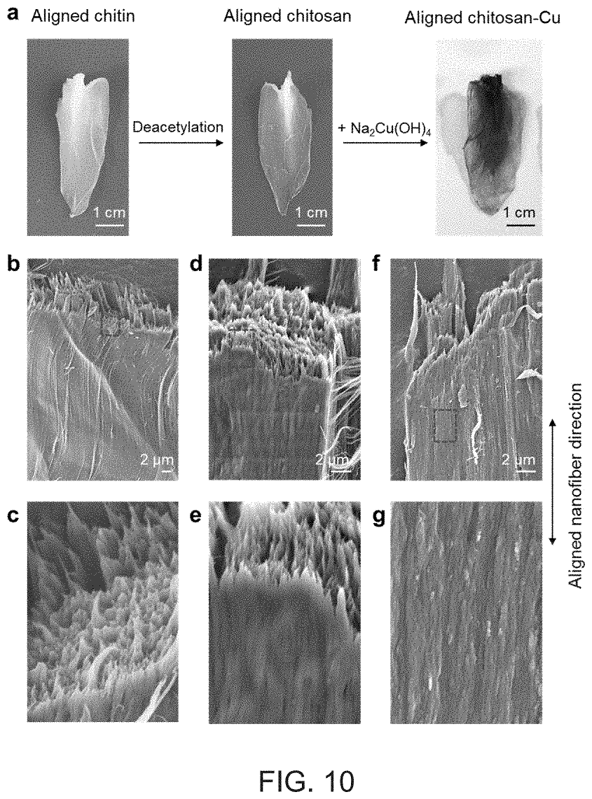

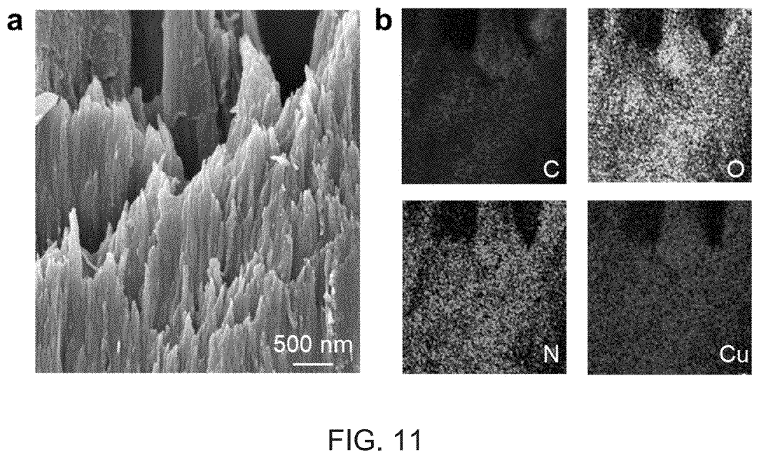

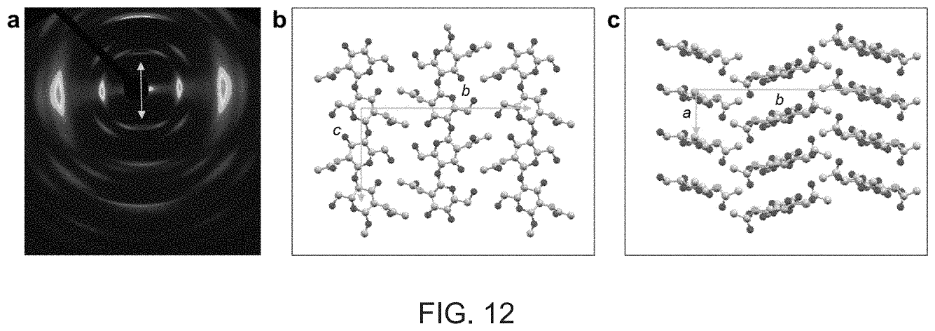

We employed 2D X-ray diffraction (XRD) to investigate how Cu²⁺ crosslinks the chitosan molecular chains and may impact the chitosan structure. As the chitosan-Cu membrane has a low crystalline degree, we used crab tendon, which consists of aligned chitin nanofibers (FIG. 10), as the starting material to fabricate aligned chitosan-Cu material (FIG. 11) for high-resolution XRD analysis. The aligned chitin shows a typical diffraction pattern of α-chitin, which features an orthorhombic crystal structure (FIG. 12, Table 3) [Ref. 23]. The aligned chitosan produced from the aligned chitin shows a similar diffraction pattern (FIG. 3, panel a) and crystal structure as α-chitin. Specifically, the chitosan molecular chains are twofold symmetric in the c direction (i.e., along the chain direction) and are antiparallel-packed along the b direction (FIG. 3, panel b), forming a sheet structure parallel to the bc-plane. These sheets are further stacked along the a direction (FIG. 3, panel c), forming an orthorhombic crystal (space group: P2₁2₁2₁, Table 3) [Ref. 24,25]. Due to strong intra- and inter-sheet hydrogen bonds in chitin/chitosan, the orthorhombic chitosan molecules are held tightly together with a small sheet distance of 0.45 nm, as determined from the 2D XRD results.

TABLE 3
The crystal structures of chitin, chitosan, and chitosan-Cu.

| | | Space | Crystal parameters (nm) | | |
|---|---|---|---|---|---|
| Material | Crystal system | group | a | b | c |
| α-Chitin | Orthorhombic | P2₁2₁2₁ | 0.474 | 1.9 | 1.0 |
| Chitosan | Orthorhombic | P2₁2₁2₁ | 0.9 | 1.7 | 1.0 |
| Chitosan-Cu | Trigonal | P3₂21 | 1.5 | 1.5 | 1.5 |

In contrast, the aligned chitosan-Cu (FIGS. 10 and 11) shows a completely different structure from that of the chitin/chitosan, as evidenced by the 2D XRD pattern (FIG. 3, panel d). Based on the absence of the (001) and (002) peaks and prominent presence of the (003) peak, we conclude that the Cu²⁺-crosslinked chitosan is a new material with a threefold symmetric conformation in the c direction. We also observed the (100) diffraction at 1.3 nm for the chitosan-Cu, based on which the unit cell parameters (a and b) were calculated to 1.5 nm (FIG. 13, panel a). Using the crystalline and bonding configurations derived from XRD and XAS, we determined the chitosan-Cu features a trigonal crystal structure (space group P3221). In this configuration, the Cu-ion species are coordinated with two chitosan chains via two hydroxyl groups (on the C2 sites) and two amino groups to form a stable square planar Cu(GLU)₂ chelate (FIG. 3, panel e). This metal ion coordination and trigonal crystal structure results in the formation of hexagonal nanochannels within the polymer (-1.0 nm in diameter, oriented along the direction of the molecular chains), which are created through the crosslinking of six chitosan helixes by three Cu²⁺ ions (FIG. 3, panel f, and FIG. 13, panel b).

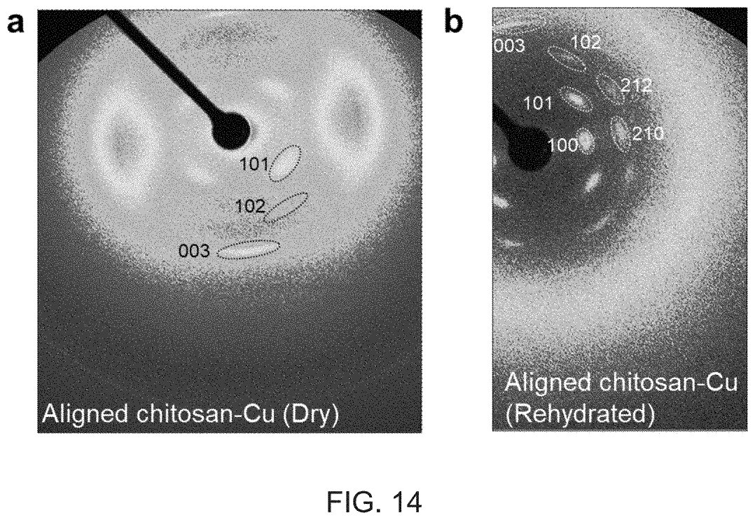

The chitosan-Cu membrane fabricated from dissolved chitosan (FIG. 2, panel a, and 2, panel b) is non-aligned, displaying diffraction rings (FIG. 3, panel g) and lower crystalline degree than the aligned chitosan-Cu (FIG. 3, panel d). Nevertheless, the XRD profile of the chitosan-Cu membrane are in good agreement with those of the aligned chitosan-Cu (FIG. 3, panel h, obtained by integrating from FIG. 3, panel g and FIG. 3, panel d), indicating the chitosan-Cu membrane is composed of small chitosan-Cu crystals with some amorphous regions (FIG. 3, panel i). Therefore, the chitosan-Cu membrane also features threefold symmetric molecular chains crosslinked by Cu²⁺ that form short-range ordered nanochannels of 1 nm, which could serve as ion transport pathways. In addition, the primary crystal structure and the nanochannels of chitosan-Cu are maintained even after drying and rehydration (FIG. 14), providing more opportunities for application in fuel cells.

### 5. OH⁻ Conductivity and Stability

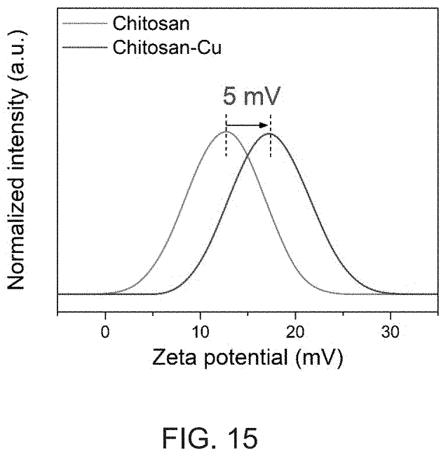

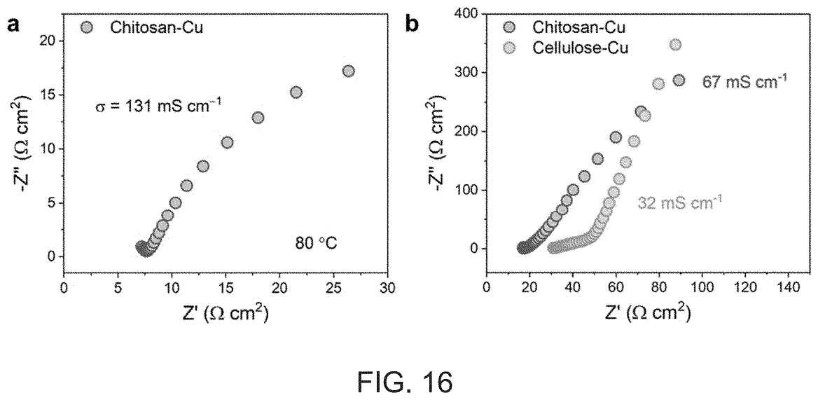

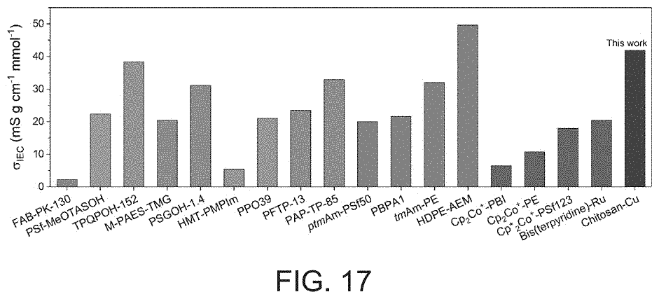

We demonstrate the chitosan-Cu material, with its rich amino groups and unique Cu²⁺-crosslinking structure, as an excellent HEM with high OH⁻ conductivity. The amino groups of chitosan and coordinated Cu²⁺ ions introduce positive charges to the chitosan-Cu, as indicated by the increased Zeta potential of 17 mV (FIG. 15), which aids in selectively attracting negative ions for ion exchange. We measured the chitosan-Cu material's OH⁻ conductivity by conducting electrochemical impedance spectroscopy (EIS) in a humidity-controlled chamber. The chitosan-Cu membrane displayed a high OH⁻ conductivity of 67 mS cm⁻¹ at 100% relative humidity and room temperature, significantly higher than that of pure chitosan treated with NaOH under the same conditions (1.7 mS cm⁻¹) (FIG. 4, panel a). When we increased the temperature to 80° C., the chitosan-Cu membrane showed a high OH⁻ conductivity of 131 mS cm⁻¹ (FIG. 16, panel a). Additionally, using the same Cu²⁺ coordination process, a similar cellulose-Cu membrane demonstrated an OH⁻ conductivity of just 32 mS cm⁻¹ at room temperature (FIG. 16, panel b), which further demonstrates the significance of the amino groups in the chitosan-Cu material in terms of its anionic transport capability. In addition, the chitosan-Cu membrane displays a high σ_{IEC} (41.9 mS g cm⁻¹ mmol⁻¹, i.e., the conductivity normalized by the ion exchange capacity (IEC)), which is among the highest σ_{IEC} reported in the literature (FIG. 17), indicating the fast OH⁻ mobility in the chitosan-Cu membrane.

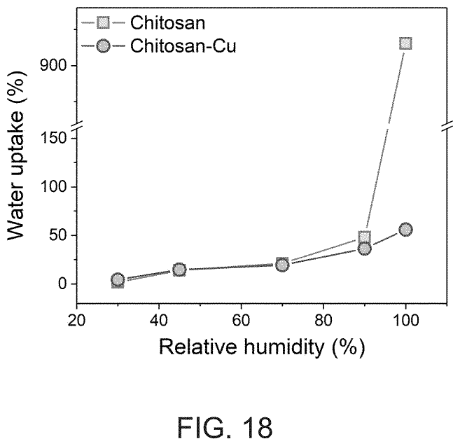

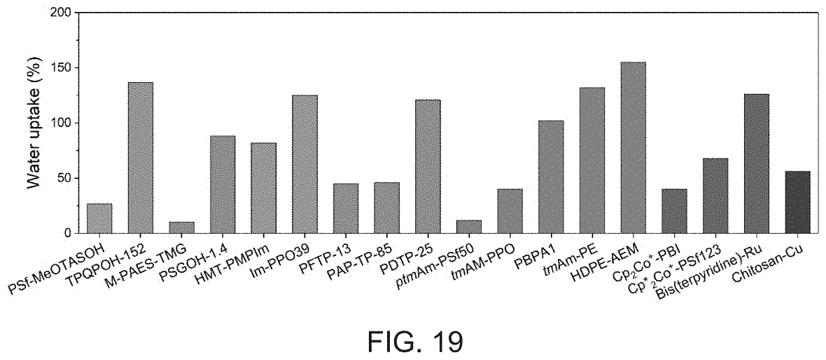

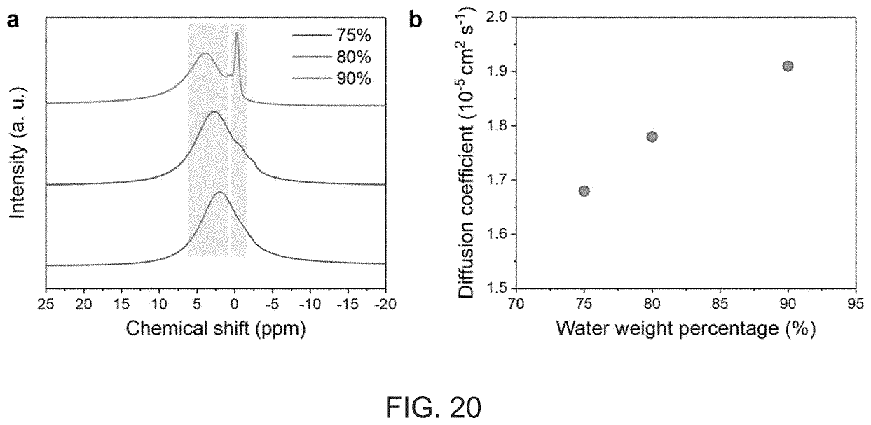

The OH⁻ conductivity (FIG. 4, panel b) and water uptake (FIGS. 18 and 19) of the chitosan-Cu membrane increases with the relative humidity, suggesting water has an important contribution to the ion transport. The chitosan-Cu membrane displays a moderate conductivity at a low relative humidity (<66%) compared with other HEMs in the literature, but higher conductivity at >66% humidity [Ref. 26]. ¹H pulsed field gradient (PFG) NMR of the chitosan-Cu membrane shows a high water self-diffusion coefficient, which increases with the water uptake (FIG. 20). The water self-diffusion coefficient of the chitosan-Cu membrane is much higher than that of other HEMs in the literature (Table 4), which is reported to be advantageous for the HEM stability in fuel cells [Ref. 27]. We hypothesize the unique 1 nm wide nanochannels of the chitosan-Cu membrane enable the high water uptake and fast diffusion, which can carry OH⁻ and aid in the OH⁻ diffusion [Ref. 28-30] (schematically illustrated in FIG. 4, panel c). Meanwhile, the coordinated Cu²⁺ cations in chitosan-Cu offer plentiful transport sites for OH⁻ (FIG. 4, panel c), further promoting the OH⁻ transport [Ref. 28,31]. As a result, the chitosan-Cu provides efficient OH⁻ conducting pathways and thus a high OH⁻ conductivity.

TABLE 4
The water self-diffusion coefficient (D_{water})
of the chitosan-Cu membrane and other HEMs.

| Material | D_{water} (10⁻¹⁰ m² s⁻¹) | | Ref. |
|---|---|---|---|
| Chitosan-Cu | 19 at 90 RH % | | This Example |
| SnowPure Excellion AEM | 1.25 | (60° C.) | 22 |
| tmAm-PPO | 0.8-2.3 | | 20 |
| TMA-20 | 3.2 | | 20 |
| HMT-PMBI | 4.9 | (CO₃²⁻) | 23 |
| Fumapem ® | 2 | (CO₃²⁻) | 23 |

SnowPure Excellion AEM: Polypropylene backbone and benzyl-trimethylammonium side
tmAm-PPO: trimethyl ammonium-based triazole-containing PPO
TMA-20: Quaternized poly(2,6-dimethylphenylene oxide)-based AEM
HMT-PMBI: Poly(benzimidazolium) AEM

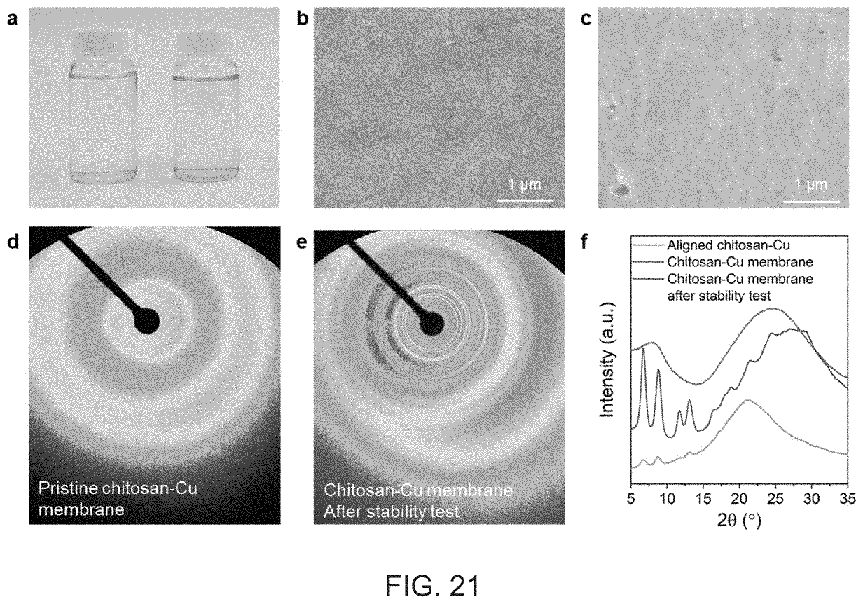

Moreover, the chitosan-Cu HEM demonstrates superb stability in harsh alkaline conditions, which is important for long lifespan fuel cells [Ref. 16]. We investigated the stability of the chitosan-Cu membrane by examining its room temperature conductivity after storing in 3 M NaOH solution at 80° C. The chitosan-Cu membrane displayed 95% conductivity retention over 1000 hours in the hot, strong basic solution, which is outstanding compared with other HEMs in terms of the OH⁻ conductivity and alkali stability (FIG. 4, panel d, and Table 5). The 5% conductivity decrease likely results from minor degradation of the Cu²⁺-chitosan coordination structure (FIG. 21, panel a). Nevertheless, the chitosan-Cu membrane does not show any obvious morphology and crystal structure change after the 1000-hour treatment in the strong basic solution at 80° C. (FIG. 4, panel e, FIG. 21, panel b-f), indicating the material's exceptional durability under these conditions.

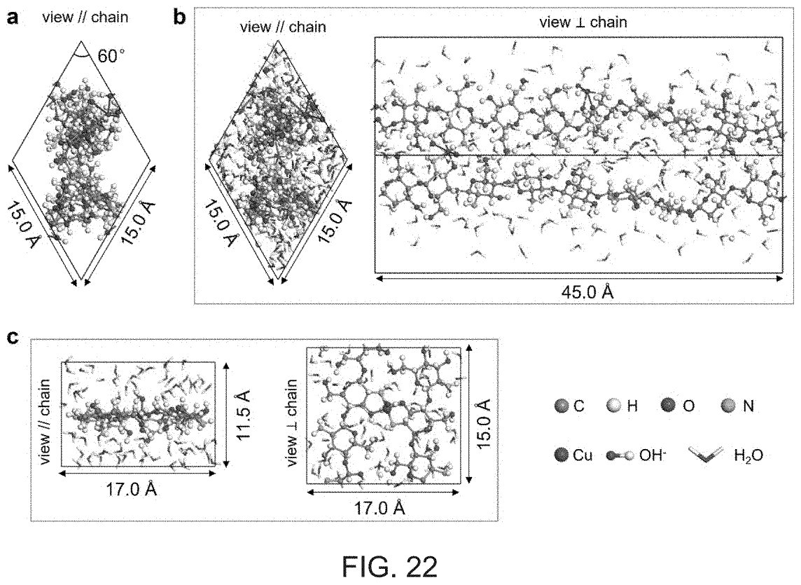

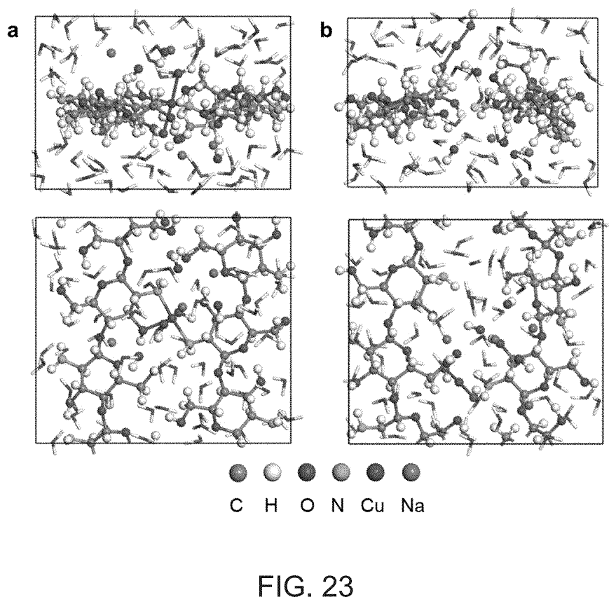

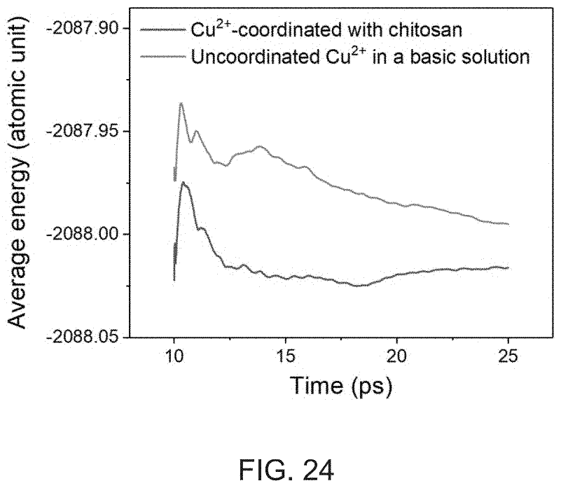

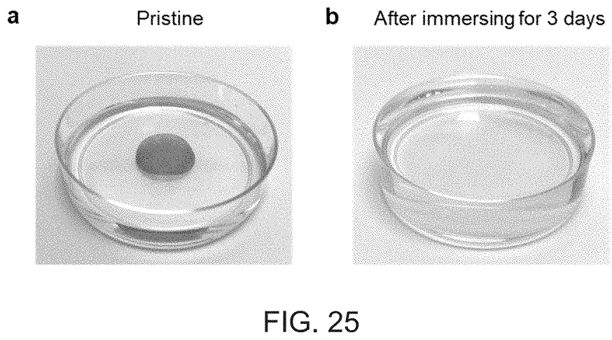

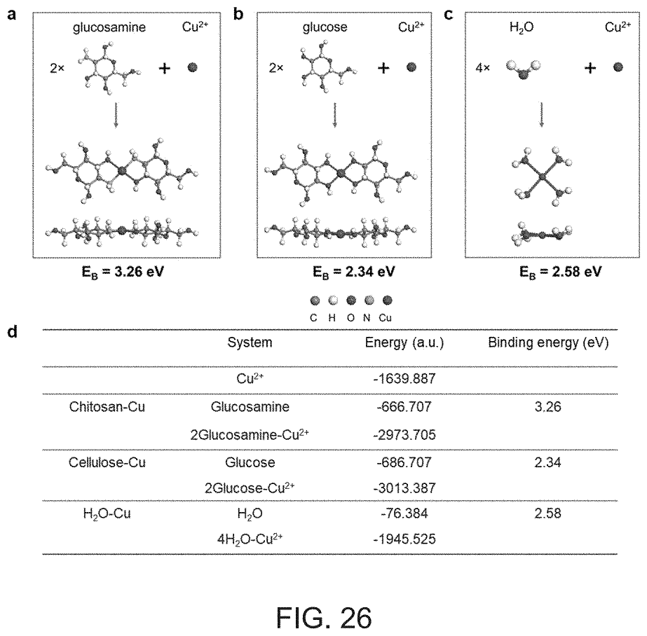

According to the ab initio molecular dynamics (AIMD) simulations of the chitosan-Cu (FIGS. 22 and 23), the bond distances of the Cu—O (˜2.79 Å) and Cu—N (˜2.10 Å) groups in the coordinated Cu²⁺ system are stable at 80° C. in the 3 M NaOH with no tendency toward bond breaking, indicating the robustness of the Cu coordination structure (Cu—N and Cu—O bonds) even under attack by OH⁻ (FIG. 4, panel f). The chitosan coordinated by Cu²⁺ is energetically favorable compared with the uncoordinated system (FIG. 24) and the unique Cu—N coordination in the chitosan-Cu membrane provides more structural stability due to the stronger binding energy of Cu—N compared to Cu—O (FIGS. 25 and 26). These experimental and computational results demonstrate the chitosan-Cu membrane can endure harsh thermal and alkaline conditions, possibly because the unique Cu-coordination structure induces delocalized charges, which decreases the possibility of OH⁻ attack, and thus enhances the durability in a harsh basic environment [Ref. 32,33]. We note that HEMs generally degrade faster at lower hydration levels (i.e., higher-concentration alkaline solutions) [Ref. 34-37]. The relatively high hydration level of 3 M NaOH (but still lower than that in many references using 1 M alkaline solution, Table 5) may have also contributed to the high HEM stability.

TABLE 5
Membrane properties of several typical HEMs.

| | | σ | | IEC | Tensile | Strength | Water | Stability | | |
|---|---|---|---|---|---|---|---|---|---|---|
| | | (mS | σ_{IEC} (S g | (mmol | strength | testing | uptake | time | Stability testing | |
| Cation | Material | cm⁻¹) | mol⁻¹ cm⁻¹) | g⁻¹) | (MPa) | condition | (%) | (h) | method | Ref. |
| Metallo- | Chitosan-Cu | 67 | 41.9 | 1.6 | 112 | Hydrated | 56 | 1000 | σ drop of 5%, | This |
| polyelectrolyte | | | | | | | | | 3M NaOH, 80° C. | work |
| | Bis (terpyridine)- | 28.6 | 20 | 1.43 | 6.2 | N/A | 126 | 48 | No change of UV-Vis, | 18 |
| | Ru | | | | | | | | 1M NaOH, 80° C. | |
| | Cp*₂Co⁺- | 22 | 18 | 1.2 | 40 | Ambient | 68 | 1000 | IEC drop of 18%, | 17 |
| | PSf123 | | | | | humidity | | | 1M KOH, 80° C. | |
| | Cp₂Co⁺-PE | 20 | 10.7 | 1.86 | N/A | N/A | N/A | 840 | σ drop of 5%, | 16 |
| | | | | | | | | | 1M NaOH, 80° C. | |
| | Cp₂Co⁺-PBI | 12.5 | 6.5 | 1.92 | 38.3 | Hydrated | 40.2 | 672 | σ drop of 15~20%, 1M | 15 |
| | | | | | | | | | KOH, 60° C. | |
| Ammonium | tmAm-PE | 48 | 32 | 1.5 | 6 | N/A | 132 | N/A | N/A | 12 |
| | btmAm-PPe | 50 | 32 | 1.56 | N/A | N/A | 44 | 672 | IEC drop of 2%, | 24 |
| | | | | | | | | | 4M NaOH, 60° C. | |
| | tmAm-PPO | 62 | 34.4 | 1.8 | N/A | N/A | 40 | 200 | σ drop of 50%, 1M | 20 |
| | | | | | | | | | KOH, 80° C. | |
| | HDPE-AEM | 121 | 49.6 | 2.44 | 35 | Ambient | 155 | 500 | σ drop of 8%, | 13 |
| | | | | | | humidity | | | 100% RH, N₂, 80° C. | |
| | PBPA1⁺ | 41 | 21.6 | 1.9 | 33 | 50% | 102 | 720 | No change, NMR, 1M | 14 |
| | | | | | | humidity | | | NaOH, 80° C. | |
| | ptmAm-PSf50 | 26 | 20 | 1.32 | 63.6 | 50% | 12 | 800 | σ drop of 78%, | 11 |
| | | | | | | humidity | | | 4M NaOH, RT | |
| Imidazolium | btmtmopIm- | 34 | 21 | 1.63 | N/A | N/A | 125 | 600 | σ drop of 17%, | 8 |
| | PPO39 | | | | | | | | 1M KOH, 60° C. | |
| | HMT-PMPIm | 14 | 8.4 | 2.61 | 43 | Ambient | 82 | 168 | No degradation from | 7 |
| | | (CO₃²_{^{−}}/ | | | | humidity | | | NMR, 10M KOH, | |
| | | HCO₃_{^{−}}) | | | | | | | 100° C. | |
| Piperidinium | PAP-TP-85 | 78 | 32.9 | 2.37 | 67 | 50% | 46 | 2000 | σ drop of <3%, | 9 |
| | | | | | | humidity | | | 1M KOH, 100° C. | |
| | PDTP-25 | 138 | 49.3 | 2.8 | 61 | Dry | 121 | 1500 | No degradation from | 19 |
| | | (60° C.) | | | | | | | NMR, 1M NaOH, | |
| | | | | | | | | | 80° C. | |
| | PFTP-13 | 66 | 23.6 | 2.82 | 84.6 | Dry | 45 | 2000 | σ drop of 3% (1M | 10 |
| | | | | | | | | | NaOH) and 22% (5M | |
| | | | | | | | | | NaOH), 80° C. | |
| Guanidinium | PSGOH-1.4 | 67 | 31.1 | 2.15 | 15.8 | 50% | 88 | 48 | No change of σ, | 5 |
| | | | | | | humidity | | | 1M NaOH, 60° C. | |
| | M-PAES-TMG | 21 | 20.4 | 1.03 | N/A | N/A | 10 | 72 | σ drop of 14%, 0.5M | 6 |
| | | | | | | | | | NaOH, 80° C. | |
| Phosphonium | TPQPOH-152 | 45 | 38.4 | 1.17 | N/A | N/A | 137 | 720 | No change of σ, 1M | 4 |
| | | | | | | | | | KOH, 60° C. | |
| | | | | | | | | | Or 5M KOH, RT | |
| | AAEM-17 | 22 | N/A | N/A | N/A | N/A | N/A | 528; | σ drop of 18%, 1M | 25 |
| | | | | | | | | 3312 | KOH, 80° C.; No | |
| | | | | | | | | | significant loss of σ, 15M | |
| | | | | | | | | | KOH, 22° C. | |
| Sulfonium | PSf- | 15.4 | 22.3 | 0.69 | N/A | N/A | 26.9 | 240; | NMR, 1M KOH, 60 ° C.; | 3 |
| | MeOTASOH | | | | | | | 720 | No obvious change of | |
| | | | | | | | | | σ, 1M KOH, RT | |

tmAm-PA: Trimethyl ammonium-based polyalkylene
btmAm-PPe: Benzyltrimethylammonium-based poly(phenylene)
tmAm-PPO: Trimethyl ammonium-based triazole-containing PPO
HDPE-AEM: Quarterly Ammonium grafted on high density polyethylene
PBPA1⁺: Trimethylammonium-based aromatic polymer
ptmAm-PSf50: Phenyltrimethylammonium-based fluorinated polysulfone
btmtmopIm-PPO39: Benzyl-1,4,5-trimethyl-2-(2,4,6-trimethoxyphenyl) imidazolium-based poly(phenylene oxide)
PDTP-25: Poly(diphenylethane-co-terphenyl piperidinium)
PFTP-13: Poly(fluorene-co-terphenyl N,N′-dimethylpiperidinium)
PSGOH: Polysulfone Containing Guanidinium Hydroxide
M-PAES-TMG: Phenyl-guanidinium-Functionalized Poly(arylene ether sulfone)
TPQPOH-152: Tris(2,4,6-trimethoxyphenyl)polysulfone-methylene quaternaryphosphonium-hydroxide
PSf-MeOTASOH: methoxylsubstituted triarylsulfonium functionalized HEM

### 6. Demonstration of Chitosan-Cu HEM in Fuel Cells

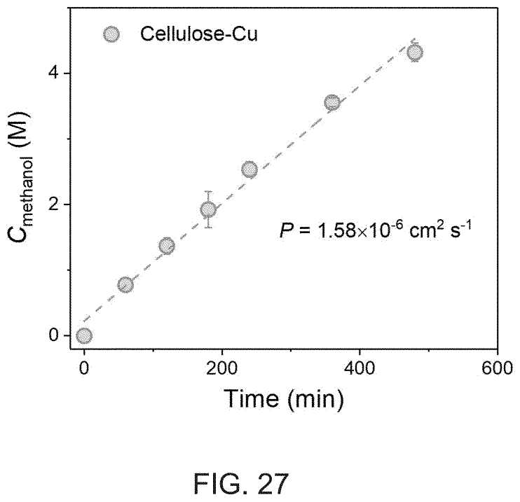

On top of the high OH⁻ conductivity and alkaline-stability, the chitosan-Cu membrane also displays low fuel permeability. The chitosan-Cu membrane shows a methanol permeability of only 1.02×10⁻⁶ cm² s⁻¹, much smaller than that of the state-of-the-art Nafion™ 212 membrane (2.06×10⁻⁶ cm² s⁻¹) (FIG. 5, panel a) and the cellulose-Cu membrane (1.58×10⁻⁶ cm² s⁻¹, FIG. 27), and comparable with other reported HEMs (Table 6). We attribute the low methanol permeability of chitosan-Cu to its dense membrane structure (FIG. 2, panel c). Additionally, the chitosan-Cu nanochannels are only ˜1 nm in diameter (smaller than the random interconnected channels of ˜2.5 nm in the Nafion™ 212 membrane [Ref. 38]), which allows fast water and OH⁻ diffusion while low fuel (e.g., methanol) crossover when applied in a fuel cell.

TABLE 6
Comparison of the methanol permeability
with other reported HEMs.

| | Methanol permeability | |
|---|---|---|
| Material | (10⁻⁶ cm² s⁻¹) | Ref. |
| Chitosan-Cu | 1.02 | This Example |
| ptmAm-PSf50 | 0.12 (at IEC = 1.68) | 11 |
| Quaternized PVA | 1.13-2.7 | 26 |
| Quaternized poly(aryl | 0.119 | 27 |
| ether oxadiazole) | | |
| Chitosan/PVA/CL | 3.38-6.67 | 28 |
| QPAES | 0.114 | 29 |

QPAES: Quaternized poly(arylene ether sulfone)

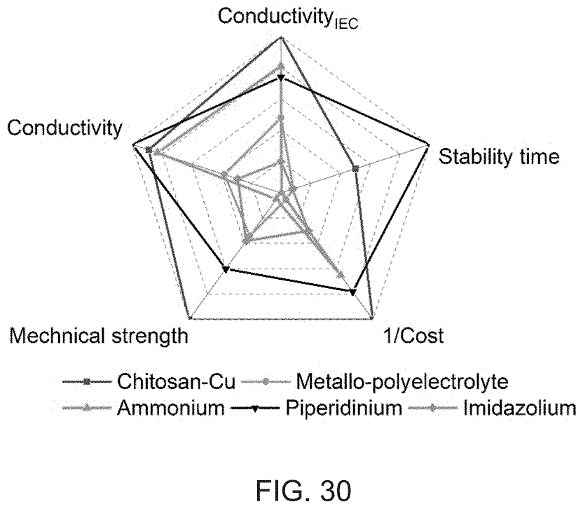

The Cu²⁺ crosslinking of the chitosan chains via Cu—N and Cu—O coordination bonds also increases the mechanical properties of the chitosan-Cu membrane, not only in dry state (FIG. 28, panel a-b) but also in hydrated state (FIG. 5, panel b, and FIG. 28, panels c-d, and FIG. 29). The chitosan-Cu membrane soaked with water maintains a tensile strength of 112 MPa, and a solid structure with little swelling (FIG. 5, panel b, and FIG. 28, panel d, and FIG. 26), which are crucial properties for the robustness of the membrane when working as an HEM in aqueous solution. The chitosan membrane soaked in water has a low tensile strength (0.5 MPa) that prevents its use as a robust ion exchange membrane (FIG. 5, panel b and FIG. 28, panel c, and FIG. 29). Compared with other typical HEMs, the chitosan-Cu membrane exhibits both high mechanical strength and hydroxide conductivity (FIG. 5, panel c). Thus, chitosan-Cu displays outstanding comprehensive properties, including high OH⁻ conductivity, excellent stability, good mechanical strength, low fuel crossover, facile fabrication, and low cost compared with other cationic HEMs, such as metallo-polyelectrolytes, ammonium, piperidinium, and imidazolium-types of HEMs (FIG. 30, Tables 5, 7-12) [Ref. 10,39-41]. These advantages make the chitosan-Cu membrane a strong HEM candidate for fuel cells.

We demonstrated the application of the promising chitosan-Cu HEM in a DMFC. In this fuel cell, 02 is reduced in the cathode to generate hydroxide ions, which transport through the HEM and react with the methanol fuel in the anode (FIG. 5, panel d), converting chemical energy to electrical energy [Ref. 8]. We coated the chitosan-Cu HEM with the cathode catalyst and sandwiched the HEM between the anode electrode and a gas diffusion layer to form a membrane electrode assembly (MEA) for the DMFC (FIG. 5, panel e; see Methods for more details). The excellent mechanical properties of the chitosan-Cu HEM make it easy to prepare the MEA and DMFC. We measured the polarization curve and power density of the chitosan-Cu membrane in the DMFC [Ref. 42]. The low methanol crossover of the chitosan-Cu membrane ensures a high fuel utilization efficiency [Ref. 43]. Using the high-conductivity chitosan-Cu HEM membrane with a thickness of 40 μm, the DMFC shows a low resistance of 53 mΩ cm2 and a high power density of 305 mW cm⁻² (FIG. 5, panel f), due to the high conductivity of the chitosan-Cu HEM. This DMFC made with the chitosan-Cu HEM displays the highest power density among DMFCs reported in the literature (using HEMs or proton exchange membranes; FIG. 5, panel g and Table 13). The outstanding performance of the DMFC validates the superior conductivity and unique structural advantage of the chitosan-Cu membrane as an ion exchange membrane for application in fuel cells.

TABLE 7
Evaluation of the fabrication and cost of several typical HEMs.

| | | Stability | |
|---|---|---|---|
| Type | Material^{a} | time (h)^{b} | Cost ($/g)^{c} |
| Metallo-polyelectrolyte | Chitosan-Cu | 1000 | 5.78 |
| | Cp₂Co⁺-PBI | 168 | 107.23 |
| Ammonium | ptmAm-PSf50 | 6 | 8.83 |
| Piperidinium | PAP-TP-85 | 2000 | 7.43 |
| Imidazolium | HMT-PMPIm | 155 | 18.48 |

^{a}One typical membrane is selected as an example for each type of cation-containing HEM membrane to evaluate its fabrication and cost. Chitosan-Cu was measured in this work. The values of the other four HEM membranes were obtained from references [Ref. 7, 9, 11, 15].
^{b}Stability time is the duration that the HEM membrane can remain in alkaline solution while retaining 90% of its initial OH⁻ conductivity. Note that the concentration and temperature of the alkaline solutions vary in different works. The chitosan-Cu in this work was treated in 3M NaOH at 80° C. Cp₂Co⁺-PBI [Ref. 15] and ptmAm-PSf50 [Ref. 11] were treated with 1M KOH at 60° C. PAP-TP-85 [Ref. 9] was treated in 1M KOH at 100° C. HMT-PMPIm [Ref. 7] was treated in 10M KOH at 100° C.
^{c}Cost was estimated by the total price of the reagents used to synthesize 1 g of the polymers. The unit prices of the reagents (ACS reagent grade) were based on those sold by Millipore Sigma. The detailed cost calculations for all polymers are listed in Tables 8-12.

TABLE 8
The cost calculation for the Chitosan-Cu synthesis.

| Chemicals | Price ($/g) | Amount (g) | Cost ($/g) |
|---|---|---|---|
| Chitosan | 1.62 | 1 | 5.78 |
| Cu wire | 7 | 0.1 | |
| NaOH | 0.0346* | 100 | |

*$415/12 kg NaOH

TABLE 9
The cost calculation for the Cp₂Co⁺ -PBI synthesis [Ref. 15].

| | Price ($/g (s) | Amount (g (s) | |
|---|---|---|---|
| Chemicals | or $/ml (I)) | or ml (I)) | Cost ($/g) |
| Methylcyclopentadiene | 0.288 | 2.73 | 107.23 |
| pyrrolidine | 0.15 | 6.81 | |
| CoCl₂ | 1.3 | 2.21 | |
| KPF₆ | 1 | 4.86 | |
| KMnO₄ | 0.162 | 7.4 | |
| 3,3′,4,4′-Biphenyltetramine | 13 | 1.04 | |
| Polyphosphoric acid | 1.15 | 61.56 | |
| DMSO | 0.178 | 111.85 | |
| Iodomethane | 0.93 | 0.66 | |

TABLE 10
The cost calculation for the ptmAm-PSf50 synthesis [Ref. 11].

| | Price ($/g (s) | Amount (g (s) | |
|---|---|---|---|
| Chemicals | or $/ml (I)) | or ml (I)) | Cost ($/g) |
| PSf | 1.65 | 0.848 | 8.83 |
| BuLi | 0.6 | 0.91 | |
| Michler's ketone | 0.435 | 1.02 | |
| Iodomethane | 0.93 | 1 | |
| DMAc | 0.14 | 15 | |
| K₂CO₃ | 0.1 | 0.15 | |
| THF | 0.179 | 41.90 | |

TABLE 11
The cost calculation for the PAP-TP-85 synthesis [Ref. 9].

| | Price ($/g (s) | Amount (g (s) | |
|---|---|---|---|
| Chemicals | or $/ml (I)) | or ml (I)) | Cost ($/g) |
| N-methyl-4-piperidone | 1.07 | 0.28 | 7.43 |
| 2,2,2-trifluoroacetophenone | 8.14 | 0.078 | |
| p-terphenyl | 1.1 | 0.69 | |
| Iodomethane | 0.93 | 1 | |
| Trifluoroacetic acid | 0.42 | 2.5 | |
| Thriflic acid (TFSA) | 0.62 | 0.2 | |
| Methylene chloride | 0.07 | 2.5 | |
| DMSO | 0.178 | 20 | |

TABLE 12
The cost calculation for the HMT-PMPIm synthesis [Ref. 7].

| | Price ($/g (s) | Amount (g (s) | |
|---|---|---|---|
| Chemicals | or $/ml (I)) | or ml (I)) | Cost ($/g) |
| Mesitaldehyde | 1.65 | 0.16 | 18.48 |
| Bromine | 0.8 | 0.17 | |
| 1,4-phenylenediboronic | 12.16 | 0.064 | |
| acid | | | |
| Bisbenzil | 21 | 0.37 | |
| Iodomethane | 0.93 | 0.57 | |
| Potassium iodide | 0.9 | 1 | |
| Dichloromethane | 0.07 | 21.2 | |
| Dimethyl sulfoxide | 0.144 | 21.2 | |
| 1,4-dioxane | 0.2 | 13.58 | |
| Ammonium acetate | 0.15 | 1.66 | |
| Glacial acetic acid | 0.1 | 6 | |

### 7. Experimental Methods

### Materials

All chemicals and solvents were purchased from Millipore Sigma unless otherwise indicated. The copper wire was purchased from McMaster-Carr. The wood pulp was purchased from International Paper. Nafion™ 212 and Fumasep FAB-PK-130 was purchased from Ion Power Inc. and Fuel Cell Inc.

### Preparation of Chitin, Chitosan, and Chitosan-Cu

The chitin was prepared from crab and shrimp shell waste, which was collected from Chesapeake blue crab and shrimp (purchased from a local seafood market). The shell waste was first washed and soaked in 1% hydrochloric acid (HCl) to remove inorganics until no more bubbling was observed. The cleaned shell was then treated in 5% NaOH overnight to remove proteins and lipids. [Ref. 22] The obtained pure chitin was then soaked in 6 M NaOH solution, sealed in a Teflon-lined hydrothermal autoclave, and heated at 100° C. overnight to convert chitin to chitosan.

The aligned chitosan was made using the same procedure except that crab tendons were used as the starting material instead of crab/shrimp shells.

To make the chitosan membrane, typically 1 g of chitosan flakes was dissolved in 200 ml of 4 wt. % acetic acid aqueous solution at room temperature by stirring overnight. After removing the undissolved flakes by filtration, a homogeneous and transparent chitosan solution was obtained. The chitosan solution (0.5 wt. %) was cast on a petri dish or a concentrated chitosan solution (˜4 wt. %) was cast using a doctor-blade on a polyethylene terephthalate (PET) film, followed by drying in air to obtain the chitosan membrane.

To prepare chitosan-Cu, a blue Cu²⁺-saturated NaOH solution (Na₂Cu(OH)₄) was first prepared by immersing excess Cu wires in 20 wt. % NaOH solution for 1 week. The concentration of saturated Cu²⁺ in the NaOH solution was ˜2 wt. %. The chitosan materials were immersed in this Na₂Cu(OH)₄ solution for 4 days until the blue color of the chitosan materials no longer changed. The chitosan-Cu materials were obtained, after rinsing with excess water to remove the physically adsorbed Cu ions and NaOH, followed by drying in air.

### Preparation Of Cellulose-Cu Control Samples

Cellulose nanofibrils were first produced by treating wood pulp using the (2,2,6,6-tetramethylpiperidin-1-yl)oxidanyl-oxidation method [Ref. 44], and then immersing the material in Na₂Cu(OH)₄ solution, producing a suspension of cellulose-Cu nanofibrils. The cellulose-Cu membrane (50 μm) was made by vacuum filtering the cellulose-Cu nanofibril slurry, followed by drying in air.

### Characterization

2D XRD was conducted on a Xenocs Xeuss SAXS/WAXS system with a Cu Kα (λ=1.5418 Å) micro-focus source and Detris Pilatus 300k detector in transmission mode in vacuum. XPS of the membranes was performed on a Thermo ESCALAB 250. The C—C peak at 284.8 eV was used as a charge correction reference. The zeta potential of the chitosan-Cu and chitosan suspensions was measured using a Zetasizer Nano S90 (Malvern Instrument). SEM was conducted at 5 kV on a Hitachi SU-70 with EDS analysis at 10 kV. FTIR was conducted with a Thermo Nicolet NEXUS 670 FTIR with an Attenuated Total Reflectance (ATR) accessory.

The X-ray absorption spectroscopy measurement at the Cu-K edge (8,979 eV) was performed on the bending-magnet beamline of the X-ray Science Division (9-BM-C) at the Advanced Photon Source, Argonne National Laboratory. The radiation was monochromatized by a Si (111) double-crystal monochromator. Harmonic rejection was accomplished with a rhodium-coated flat mirror. The energy was calibrated with Cu foil at the Cu—K edge. All the spectra were collected in fluorescence mode by a 4-element Vortex detector.

Diffusion nuclear magnetic resonance (NMR) measurements were performed on a 300 MHz NMR spectrometer operating at a magnetic field of 7 T for ¹H NMR using a DOTY Z-spec pulsed field gradient (PFG) NMR probe. A simple spin echo diffusion pulse sequence was used to measure the diffusion coefficients. The signal was accumulated by varying the gradient strength from 100-2050 G/cm in 16 increments. The diffusion time and the diffusion pulse length were in the range of 0.004-0.006 s and 0.0012-0.002 s, respectively. The diffusion coefficients were calculated using the Stejskal-Tanner equation [Ref. 45]. The samples for NMR measurement were prepared by packing vacuum-dried chitosan-Cu membranes into 5 mm NMR tubes, injecting proper amounts of deionized water (75%—90% of the mass of the dry membrane) and finally equilibrated inside the sealed NMR tubes at room temperature for at least 48 hours.

The Cu-ion content of the chitosan-Cu membrane and Na₂Cu(OH)₄ solution were measured by PerkinElmer NexION 300D ICP-MS, where ⁶³Cu standard solutions were used to construct a calibration curve. For ICP measurement, the chitosan-Cu membrane was dissolved in 2 wt. % nitric acid as the testing solution, the Cu²⁺-0 concentration of which was used to calculate the Cu content in chitosan-Cu.

The tensile strain-stress of the chitosan and chitosan-Cu membranes were tested by a tabletop model testing system (Instron, USA) with a running speed of 0.5 mm min⁻¹. Rectangular films (thickness: 40 μm) were pretreated by immersing in water for 1 hour before testing the tensile performance of the resulting water-soaked chitosan and chitosan-Cu membranes.

The IEC of the chitosan-Cu membrane was measured using the back-titration method. The membrane was immersed in a 0.01 M HCl standard solution (50 ml) for 24 hours and then titrated by a standard 0.01 M NaOH solution until pH=7.0. The IEC was calculated by

$$I E C = \frac{{c}_{{HCl}^{V} HCl} - {c}_{{NaOH}^{V} NaOH}}{{m}_{dry}} \qquad ( 1 )$$

where m_{dry} is the mass of the dry chitosan-Cu membrane, C_{HCl} and C_{NaOH} are the concentrations of the HCl and NaOH solutions, respectively, and V_{HCl} and V_{NaOH} are the volumes of the HCl and NaOH solutions, respectively.

### Water Uptake Measurement

The mass of a dry membrane (after drying under vacuum overnight) was measured as the dry mass (m_{dry}). The membrane was then further conditioned in a humidity-controlled chamber for 12 hours at different relative humidity to achieve the wet mass (m_{wet}). The water uptake was calculated by

$$Water uptake = \frac{{m}_{wet} - {m}_{dry}}{{m}_{dry}} \qquad ( 2 )$$

### Methanol Permeability Measurement

The apparent methanol permeability of the membranes was measured at 25° C. using synthesized chitosan-Cu and cellulose-Cu membranes. A commercial Nafion™ 212 membrane was used for the control experiment. The thickness of the hydrated chitosan-Cu, cellulose-Cu, and Nafion™ 212 membranes was 110 μm, 81 μm, and 55 μm, respectively. The membranes were clamped between two glass cells of ˜125 ml capacity with an inner area (A) of 4.5 cm². The left reservoir was filled with 120 ml of methanol with a concentration (C_{A}) of 22 M and the right receiving reservoir was filled with water with a volume (V_{B}) of 120 ml. Solutions in both reservoirs were vigorously stirred at the same speed. The concentration of methanol as a function of time (C_{B}(t)) in the receiving reservoir was determined by measuring the density of the solution, which was repeated five times at certain intervals of time (1-3 hours). A calibration curve of the density versus methanol concentration was obtained prior to the permeation measurements. The apparent methanol permeability (P) was calculated according to the equation:

$${C}_{B} ( t ) = \frac{{PAC}_{A}}{{V}_{B} L} t \qquad ( 3 )$$

where L is the membrane thickness and t is the permeating time of methanol through the membranes.

### Hydroxide Conductivity Measurement

Before the hydroxide conductivity measurement, the chitosan-Cu membranes were immersed in 3 M NaOH for 24 hours and washed with water to remove excess NaOH. The in-plane hydroxide conductivity of the chitosan-Cu membrane was measured by EIS in a humidity-controlled chamber. The EIS was measured using a Biologic electrochemical station with frequency from 100 kHz to 1 Hz. The hydroxide conductivity (a) was calculated by the equation:

$$σ = \frac{L}{R \times S} \qquad ( 4 )$$

where L is the length of the chitosan-Cu membrane, R is the resistance obtained by the EIS test (the real axis value at the high frequency intercept), and S is the cross-sectional area of the membrane.

### MEA Preparation And DMFC Measurements

Commercial PtRu/C (Alfa Aesar, 60% PtRu on Vulkan XC-72, Pt:Ru=2:1) and Acta 4020 (Acta S.p.A) were used as the anode and cathode catalysts, respectively. The electrode ink was prepared by adding catalyst and ionomers (PiperION PAP-TP-100 ionomer for the anode and AS-4 ionomer for the cathode) into isopropanol solvent, followed by sonication for 1 hour in an ice-water bath. The weight ratios of the catalyst and ionomer for the anode and cathode were 9:1 and 8:2, respectively. The hydrophilic PiperION PAP-TP-100 ionomer was used in the anode to facilitate the transport of the aqueous methanol solution [Ref. 41]. The hydrophobic AS-4 ionomer (20 wt. %) was used to alleviate the cathode flooding issue [Ref. 46]. The anode was prepared by spraying PtRu/C catalysts on carbon cloth with a loading of 2 mg_{PGM} cm⁻², and the cathode was constructed by spraying catalysts onto chitosan-Cu membranes with a loading of 3 mg_{Acta} cm⁻². The MEAs with an active area of 5 cm2 were assembled with an anode electrode, a chitosan-Cu membrane coating with a cathode catalysts layer, a gas diffusion layer (SGL 29 BC) in the cathode, two fluorinated ethylene propylene gaskets, two graphite plates with 5 cm² flow field (ElectroChem), and metal current collectors.

A fuel cell test station was used to collect polarization curves of the prepared DMFCs. The experiments were performed at 80° C. and ambient pressure. The fuel cell temperature was controlled by a feedback loop comprised of electric heating tape and a thermocouple-based thermometer in the end plates. The default testing was performed using 5 ml min⁻¹ of 3 M methanol in 6 M KOH as the anode fuel and 500 ml min⁻¹ O₂ as the cathode fuel at 80° C.

### AIMD Simulation

A system containing one Cu²⁺, two OH⁻, six GLUs (two chitosan chains), and 66 H₂O molecules was used to perform the AIMD simulations. The two chitosan chains (each with three GLUs) were connected by one Cu²⁺ by coordinating with the hydroxyl O atoms and N atoms of the amino groups. Note that the amount of each element (Cu²⁺, OH⁻ and H₂O) was calculated from the Cu²⁺ ratio, IEC, and water uptake, respectively. Four out of the 66 H₂O molecules were replaced by four NaOH to mimic the 3 M NaOH aqueous solution. Another system of uncoordinated Cu²⁺ in a NaOH aqueous solution was constructed as a control of the coordinated Cu²⁺.

The geometry optimizations and AIMD simulations under NVT ensemble (constant number of atoms, volume, and temperature) were performed using the CP2K package (version 8.1). The Gaussian and plane waves (GPW) method as implemented in the QUICKSTEP module [Ref. 47] was adopted. The Goedecker-Teter-Hutter pseudopotentials along with DZVP basis set [Ref. 48] were used and truncated at 280 Ry. The BLYP functional [Ref. 49] with D3 dispersion correction [Ref. 50] was used, which works very well for liquid water systems [Ref. 51]. A Nose-Hoover thermostat [Ref. 52] was used for controlling the temperature at 353 K (or 80° C.). The time step was set to 1.0 fs and the total simulation time was 25.0 ps. The first 10.0 ps of the AIMD simulations were for equilibration, and the last 15.0 ps were taken for energy analyses. Total energies taken from the last 15.0 ps for the two systems were compared, which can be used to check if Cu²⁺ tends to be bound with chitosan or dissolve in solution. For the system in which Cu²⁺ is coordinated with chitosan, the bond distances between Cu and its associated O and N atoms from GLUs were monitored to confirm its stability.

### DFT Calculations

A system including two glucosamine, two glucose units or four H₂O molecules and one Cu²⁺ were used to perform DFT calculations of the binding energies of model systems of chitosan-Cu, cellulose-Cu, and Cu-water, respectively. Binding energy is defined as E_{b}=2×Eᵤₙᵢₜ+E_{Cu}_{²⁺}−Eₜₒₜₐₗ, where Eᵤₙᵢₜ denotes the energy of the glucosamine or glucose unit, E_{Cu}_{²⁺} refers to the energy of Cu²⁺, and Eₜₒₜₐₗ refers to the energy of the connected system of 2Glucosamine-Cu²⁺ and 2Glucose-Cu²⁺.

DFT calculations were performed using the Gaussian 09 code (Revision D.01). The hybrid PBEO functional [Ref. 53] and the basis set 6-311+G** were used for geometry optimizations and energy calculations. The D3 version of Grimme's dispersion with Becke-Johnson damping [Ref. 50] was adopted to correct for the weak interactions. The implicit solvation model SMD [Ref. 54] was used. The dielectric constant was set to 78.4 to represent the water system.

### 8. CONCLUSIONS

In summary, we have developed a Cu²⁺-coordinated chitosan material and demonstrated its excellent performance as an HEM. The chitosan-Cu was fabricated from the cationic polymer chitosan using a facile and scalable solution-based approach. The process converts the orthorhombic crystal structure of chitosan to a trigonal crystal structure, comprising crosslinked chitosan chains through the coordination of Cu²⁺ with the —NH₂ and —OH groups of chitosan. Due to the unique structure of the Cu²⁺-crosslinked chitosan chains, in which six chains are connected by Cu²⁺ to form a -1 nm wide hexagonal nanochannel, chitosan-Cu achieves fast OH⁻ transport for high OH⁻ conductivity (67 mS cm⁻¹), in addition to low methanol crossover and good structural strength. The strong bonding of Cu—N and Cu—O in chitosan-Cu ensures the material's structural stability, even under harsh alkaline conditions. These features make chitosan-Cu an excellent ion exchange membrane for fuel cells, which we demonstrate in a DMFC with a high power density of 305 mW cm⁻². This concept of using metal ions to crosslink polymers to form new HEM materials suggests an avenue for the development of high-conductivity and alkali-stable anion exchange membranes, as well as the revalorization of naturally abundant biomaterial in value-added systems.

### REFERENCES

1. Varcoe, J. R. et al. Anion-exchange membranes in electrochemical energy systems. Energy Environ. Sci. 7, 3135-3191, (2014).
2. Arges, C. G. & Zhang, L. Anion exchange membranes evolution toward high hydroxide ion conductivity and alkaline resiliency. ACS Appl. Energy Mater. 1, 2991-3012, (2018).
3. Lu, S., Pan, J., Huang, A., Zhuang, L. & Lu, J. Alkaline polymer electrolyte fuel cells completely free from noble metal catalysts. PNAS 105, 20611, (2008).
4. Xiong, P., Zhang, L., Chen, Y., Peng, S. & Yu, G. A chemistry and microstructure perspective on ion-conducting membranes for redox flow batteries. Angew. Chem. Int. Ed. 60, 2-31, (2021).
5. Kusoglu, A. & Weber, A. Z. New insights into perfluorinated sulfonic-acid ionomers. Chem. Rev. 117, 987-1104, (2017).
6. Gasteiger, H. A. & Marković, N. M. Just a Dream—or Future Reality? Science 324, 48, (2009).
7. Jin, Z. et al. Understanding the inter-site distance effect in single-atom catalysts for oxygen electroreduction.Nat. Catal. 4, 615-622, (2021).
8. Hren, M., Božič, M., Fakin, D., Kleinschek, K. S. & Gorgieva, S. Alkaline membrane fuel cells: anion exchange membranes and fuels. Sustain. Energy Fuels 5, 604-637, (2021).
9. Setzler, B. P., Zhuang, Z., Wittkopf, J. A. & Yan, Y. Activity targets for nanostructured platinum-group-metal-free catalysts in hydroxide exchange membrane fuel cells. Nat. Nanotech. 11, 1020-1025, (2016).
10. Li, N., Zhang, Q., Wang, C., Lee, Y. M. & Guiver, M. D. Phenyltrimethylammonium functionalized polysulfone anion exchange membranes. Macromolecules 45, 2411-2419, (2012).
11. Kostalik, H. A. et al. Solvent processable tetraalkylammonium-functionalized polyethylene for use as an alkaline anion exchange membrane. Macromolecules 43, 7147-7150, (2010).
12. Hugar, K. M., Kostalik, H. A. & Coates, G. W. Imidazolium cations with exceptional alkaline stability: A systematic study of structure—stability relationships. J. Am. Chem. Soc. 137, 8730-8737, (2015).
13. Sata, T., Yamane, Y. & Matsusaki, K. Preparation and properties of anion exchange membranes having pyridinium or pyridinium derivatives as anion exchange groups. J. Polym. Sci. A Polym. Chem. 36, 49-58, (1998).
14. Sun, Z., Pan, J., Guo, J. & Yan, F. The alkaline stability of anion exchange membrane for fuel cell applications: The effects of alkaline media. Adv. Sci. 5, 1800065, (2018).
15. Wang, J., Gu, S., Kaspar, R. B., Zhang, B. & Yan, Y. Stabilizing the imidazolium cation in hydroxide-exchange membranes for fuel cells. ChemSusChem 6, 2079-2082, (2013).
16. Mustain, W. E., Chatenet, M., Page, M. & Kim, Y. S. Durability challenges of anion exchange membrane fuel cells. Energy Environ. Sci. 13, 2805-2838, (2020).
17. Noh, S., Jeon, J. Y., Adhikari, S., Kim, Y. S. & Bae, C. Molecular engineering of hydroxide conducting polymers for anion exchange membranes in electrochemical energy conversion technology. Acc. Chem. Res. 52, 2745-2755, (2019).
18. Kim, S.-K. Chitin, chitosan, oligosaccharides and their derivatives: Biological activities and applications. 1st edn, (CRC Press, 2011).
19. Xu, C., Nasrollahzadeh, M., Selva, M., Issaabadi, Z. & Luque, R. Waste-to-wealth: Biowaste valorization into valuable bio(nano)materials. Chem. Soc. Rev. 48, 4791-4822, (2019).
20. Ogawa, K., Hirano, S., Miyanishi, T., Yui, T. & Watanabe, T. A new polymorph of chitosan. Macromolecules 17, 973-975, (1984).
21. Kraytsberg, A. & Ein-Eli, Y. Review of advanced materials for proton exchange membrane fuel cells. Energy & Fuels 28, 7303-7330, (2014).
22. Peter, S. et al. Chitin and chitosan based composites for energy and environmental applications: A review. Waste Biomass Valorization 12, 4777-4804, (2020).
23. Sikorski, P., Hori, R. & Wada, M. Revisit of α-chitin crystal structure using high resolution X-ray diffraction data. Biomacromolecules 10, 1100-1105, (2009).
24. Okuyama, K. et al. Structural diversity of chitosan and its complexes. Carbohydr. Polym. 41, 237-247, (2000).
25. Ogawa, K., Oka, K. & Yui, T. X-ray study of chitosan-transition metal complexes. Chem. Mater. 5, 726-728, (1993).
26. Li, N., Guiver, M. D. & Binder, W. H. Towards high conductivity in anion-exchange membranes for alkaline fuel cells. ChemSusChem 6, 1376-1383, (2013).
27. Yassin, K., Rasin, I. G., Brandon, S. & Dekel, D. R. Quantifying the critical effect of water diffusivity in anion exchange membranes for fuel cell applications. J. Membr. Sci. 608, 118206, (2020).
28. Zelovich, T. et al. Hydroxide ion diffusion in anion-exchange membranes at low hydration: Insights from ab initio molecular dynamics. Chem. Mater. 31, 5778-5787, (2019).

29. Zadok, I., Dekel, D. R. & Srebnik, S. Effect of ammonium cations on the siffusivity and structure of hydroxide ions in low hydration media.J. Phys. Chem. C 123, 27355-27362, (2019).
30. Tuckerman, M. E., Chandra, A. & Marx, D. Structure and dynamics of OH-(aq). Acc. Chem. Res. 39, 151-158, (2006).

31. Zadok, I. et al. Unexpected hydroxide ion structure and properties at low hydration. J. Mol. Lip. 313, 113485, (2020).
32. Zha, Y., Disabb-Miller, M. L., Johnson, Z. D., Hickner, M. A. & Tew, G. N. Metal-cation-based anion exchange membranes. J. Am. Chem. Soc. 134, 4493-4496, (2012).
33. Gu, S. et al. Permethyl cobaltocenium (Cp*₂Co⁺) as an ultra-stable cation for polymer hydroxide-exchange membranes. Sci. Rep. 5, 11668, (2015).
34. Diesendruck, C. E. & Dekel, D. R. Water—A key parameter in the stability of anion exchange membrane fuel cells. Curr. Opin. Electrochem. 9, 173-178, (2018).
35. Dekel, D. R. et al. Effect of water on the stability of quaternary ammonium groups for anion exchange membrane fuel cell applications. Chem. Mater. 29, 4425-4431, (2017).
36. Gjineci, N., Aharonovich, S., Dekel, D. R. & Diesendruck, C. E. Increasing the alkaline stability of N,N-diaryl carbazolium salts using substituent electronic effects. ACS Appl. Mater. Interfaces 12, 49617-49625, (2020).
37. Dekel, D. R. et al. The critical relation between chemical stability of cations and water in anion exchange membrane fuel cells environment. J. Power Sources 375, 351-360, (2018).
38. Allen, F. I. et al. Morphology of hydrated as-cast nafion revealed through cryo electron tomography. ACS Macro Lett. 4, 1-5, (2015).
39. Chen, N. et al. Cobaltocenium-containing polybenzimidazole polymers for alkaline anion exchange membrane applications. Polymer Chem. 8, 1381-1392, (2017).
40. Fan, J. et al. Cationic polyelectrolytes, Stable in 10 M KOH_{aq} at 100° C. ACS Macro Lett. 6, 1089-1093, (2017).
41. Wang, J. et al. Poly(aryl piperidinium) membranes and ionomers for hydroxide exchange membrane fuel cells. Nat. Energy 4, 392-398, (2019).
42. Liu, G. et al. Composite membranes from quaternized chitosan reinforced with surface-functionalized PVDF electrospun nanofibers for alkaline direct methanol fuel cells. J. Membr. Sci. 611, 118242, (2020).
43. Heinzel, A. & Barragán, V. M. A review of the state-of-the-art of the methanol crossover in direct methanol fuel cells. J. Power Sources 84, 70-74, (1999)
44. Zhu, H. et al. Anomalous scaling law of strength and toughness of cellulose nanopaper. PNAS 112, 8971, (2015).
45. Di Noto, V. et al. Inorganic—organic membranes based on Nafion, [(ZrO₂).(HfO₂)_{0.25]} and [(SiO₂).(HfO₂)_{0.28]} nanoparticles. Part II: Relaxations and conductivity mechanism. Int. J. Hydrogen Energy 37, 6215-6227, (2012).
46. Kaspar, R. B. et al. Manipulating water in high-performance hydroxide exchange membrane fuel cells through asymmetric humidification and wetproofing. J. Electrochem. Soc. 162, F483-F488, (2015).
47. VandeVondele, J. & Hutter, J. Gaussian basis sets for accurate calculations on molecular systems in gas and condensed phases. J. Chem. Phys. 127, 114105, (2007).
48. Goedecker, S., Teter, M. & Hutter, J. Separable dual-space Gaussian pseudopotentials. Phy. Rev. B 54, 1703-1710, (1996).
49. Becke, A. D. Density-functional exchange-energy approximation with correct asymptotic behavior. Phy. Rev. A 38, 3098-3100, (1988).
50. Grimme, S., Ehrlich, S. & Goerigk, L. Effect of the damping function in dispersion corrected density functional theory. J. Comput. Chem. 32, 1456-1465, (2011).
51. Gillan, M. J., Alfè, D. & Michaelides, A. Perspective: How good is DFT for water? J. Chem. Phys. 144, 130901, (2016).
52. Nosé, S. A molecular dynamics method for simulations in the canonical ensemble. Molecular Phys. 52, 255-268, (1984).
53. Adamo, C. & Barone, V. Toward reliable density functional methods without adjustable parameters: The PBEO model. J. Chem. Phys. 110, 6158-6170, (1999).
54. Marenich, A. V., Cramer, C. J. & Truhlar, D. G. Universal solvation model based on solute electron density and on a continuum model of the solvent defined by the bulk dielectric constant and atomic surface tensions. J. Phys. Chem. B 113, 6378-6396, (2009).

The citation of any document is not to be construed as an admission that it is prior art with respect to the present disclosure.

Thus, examples of the present disclosure provide ion exchange membranes that can facilitate transport of ions with wide applications in electrochemical devices, such as fuel cells, flow batteries, and electrolyzers.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in an embodiment”, “in some embodiments”, “in a further embodiment”, or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the present disclosure has been described in considerable detail with reference to certain embodiments, one skilled in the art will appreciate that aspects of the present disclosure can be used in alternative embodiments to those described, which have been presented for purposes of illustration and not of limitation. Therefore, the scope of the appended claims should not be limited to the description of the embodiments contained herein.

1. An ion exchange membrane comprising:
a plurality of chitosan molecular chains crosslinked with a crosslinking agent selected from the group consisting of multivalent cations and mixtures thereof,
wherein the ion exchange membrane has a structure including a crystalline crosslinking zone.

2. The ion exchange membrane of claim 1 wherein:
the membrane has a hydroxide conductivity of greater than 10 mS cm⁻¹ at room temperature.

3. (canceled)

4. The ion exchange membrane of claim 1 wherein:
the membrane includes polygonal nanochannels.

5. The ion exchange membrane of claim 1 wherein:
the membrane includes hexagonal nanochannels having a width in a range of 0.1 to 5 nanometers.

6. (canceled)

7. The ion exchange membrane of claim 1 wherein:
the chitosan molecular chains have a threefold helical conformation.

8. The ion exchange membrane of claim 1 wherein:
the multivalent cations are coordinated with amino groups and hydroxyl groups of the chitosan molecular chains.

9. (canceled)

10. The ion exchange membrane of claim 1 wherein:
the multivalent cations are selected from the group consisting of ions of copper.

11. (canceled)

12. The ion exchange membrane of claim 1 wherein:
the membrane has a trigonal crystal structure.

13. (canceled)

14. The ion exchange membrane of claim 1 wherein:
the membrane has a σ_{IEC} of greater than 30 mS g cm⁻¹ mmol⁻¹.

15. The ion exchange membrane of claim 1 wherein:
the membrane has a thickness in a range of 1 to 100 micrometers.

16. The ion exchange membrane of claim 1 wherein:
the membrane includes 1 wt. % to 10 wt. % of the crosslinking agent based on total weight percent of the membrane.

17. The ion exchange membrane of claim 1 wherein:
the membrane has a water self-diffusion coefficient (D_{water}) greater than 10×10⁻¹⁰ m² s⁻¹ at 90% relative humidity. water.

18. The ion exchange membrane of claim 1 wherein:
the membrane has a methanol permeability of less than 1.5×10⁻¹⁰ m² s⁻¹.

19. The ion exchange membrane of claim 1 wherein:
the membrane maintains a tensile strength of at least 100 MPa when soaked with

20. The ion exchange membrane of claim 1 wherein:
the membrane in an anion exchange membrane.

21. (canceled)

22. The ion exchange membrane of claim 1 wherein:
the membrane has a water uptake of less than 60%.

23. (canceled)

24. An electrochemical device comprising:
an anode;
a cathode; and
an ion exchange membrane positioned between the anode and the cathode,
wherein the ion exchange membrane comprises a plurality of chitosan molecular chains crosslinked with a crosslinking agent selected from the group consisting of multivalent cations and mixtures thereof.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. The device of claim 24 wherein:
the device is a direct methanol fuel cell that exhibits a power density of greater than 300 mW cm⁻².

47. The device of claim 24 wherein:
the device is an alkaline anion exchange membrane fuel cell.

48. (canceled)

49. (canceled)

50. (canceled)

51. (canceled)

52. (canceled)

53. (canceled)

54. A method for forming an ion exchange membrane, the method comprising:
(a) casting a flowable composition including chitosan on a support to form a chitosan membrane on the support;
(b) advancing the support into a region wherein the chitosan membrane is contacted with a crosslinking agent selected from the group consisting of multivalent cations and mixtures thereof to form on the support an ion exchange membrane comprising a plurality of chitosan molecular chains crosslinked with the crosslinking agent; and
(c) separating the ion exchange membrane from the support.

55. (canceled)

56. (canceled)

57. (canceled)

58. (canceled)
